(19) United States
(12) Patent Application Publication
(10) Pub. No.: US 2026/0016098 A1
(43) Pub. Date: Jan. 15, 2026

(54) MODULAR SKID AND FLUID FLOW DEVICE ARRANGEMENTS FOR EBULLATED BED HYDROCRACKING APPLICATIONS

(71) Applicant: Velan Inc., Montreal, Québec (CA)

(72) Inventors: Duc Thanh TRAN, Montreal, Québec (CA); Luc David VERNHES, Montreal, Québec (CA); Vinh Van NGUYEN, Laval, Québec (CA)

(21) Appl. No.: 18/994,256

(22) PCT Filed: Jul. 14, 2023
(86) PCT No.: PCT/IB2023/057240

§ 371 Date: Jan. 14, 2025

Related U.S. Application Data
(60) Provisional application No. 63/389,207, filed on Jul. 14, 2022.
(60) Provisional application No. 63/422,486, filed on Nov. 4, 2022.

(51) Int. Cl. F16K 11/22; F16L 41/02

(52) U.S. Cl. CPC F16K 11/22; F16L 41/023

(57) ABSTRACT

Modular skids for severe service applications, and fluid flow device arrangements (modules) for use therein are described. The modular skids and/or the described modules provide for skids that are at least one of, more compact, less costly, less heavy, more serviceable and/or provides for more uptime of the skid than conventional skids.

### CROSS-REFERENCES TO RELATED APPLICATIONS

This application claims priority to U.S. Provisional Application No. 63/422,486 filed Nov. 4, 2022, and to U.S. Provisional Application No. 63/389,207 filed Jul. 14, 2022, the content of each of which is herein incorporated by reference in its entirety.

### STATEMENT REGARDING FEDERALLY SPONSORED RESEARCH OR DEVELOPMENT

(NOT APPLICABLE)

### BACKGROUND

Oil and gas industries, among others, typically require fluid flow devices and related equipment engineered for “severe service.” Most experts agree that severe service valves (SSVs) are identified by applications, and that these applications are challenging to the valve's ability to provide a minimum acceptable level of performance over a minimum acceptable duration. Severe service conditions always apply to the following: autoclave let-down, boiler feedwater, choke valves, coal gasification, compressor anti-surge, engine test stands, fluids with high, out-gassing potential, HP separator drain, minimum flow recycle, solar power molten salt, slurry control, toxic/lethal service, and turbine by-pass. The article “Defining severe service valves,” by Valve World Publisher, Valve World, May 16, 2017 (https://valve-world.net/defining-severe-service-valves/; (accessed Jun. 29, 2022), herein incorporated by reference in its entirety. Fluid flow devices (e.g., pipes, valves, nozzles and the like) subjected to thermal and/or pressure shocks common in severe industrial applications are subject to wear and tear, and the failure or downtime for such equipment can be costly. Fluid flow devices subject to cyclic high pressure and temperature changes are prone to failure due to thermal shock. Thermal shock refers to a process wherein the flow device experiences sudden large magnitude changes in thermal stress when the heat flux and temperature gradient experienced by the flow device change abruptly. In addition to thermal shocks, contaminant or sludge buildup and damage caused by contaminants are some other frequent problems in severe service fluid flow devices. Thus, fluid flow devices can benefit from improved serviceability so that the devices can be operated as intended in the face of stresses to prevent premature thermal and/or pressure fatigue.

Redundancy of equipment, such as, providing for redundant fluid flow paths such that when one fluid flow path is disabled (e.g., for servicing or repairing damage) one or more other paths can temporarily accommodate the fluid flow is highly desired in severe service applications. Thus, fluid flow device arrangements currently existing for severe service provide redundant legs or pathways of a process flow in a configuration that allows for selectively isolating two pathways to maintain a process flow (or isolation) via one pathway, while providing service or maintenance on the unused, pathway. U.S. Pat. No. 9,366,347 titled “Multiport Severe Service Ball Valve” describes an arrangement in which a single “multiport valve” integrates a severe service ball valve in each of a plurality of fluid pathways.

Due to the complexity of the fluid flow device arrangements and the challenges of assembling/constructing such arrangements on-site (e.g., oil and/or gas drilling sites) in severe service industries, a preference is emerging for pre-assembled configurations of fluid flow devices that, for a specific process application, incorporates multiple severe service valves on each of multiple redundant paths, known as a “skid”, being transported to as a single module and then deployed on-site. A skid arrangement described in U.S. Pat. No. 9,366,347 as a “a modular multiport valve system” uses two of the multiport valves described therein as the input and the output of the modular multiport valve system.

However, when the severe service ball valve on any one of the redundant legs of a multiport valve of U.S. Pat. No. 9,366,347 is disabled and/or requires maintenance, the entire multiport valve must be replaced. This may lead to unnecessary downtime in skid arrangements that have the multiport valve of U.S. Pat. No. 9,366,347 deployed.

Thus, improved skid arrangements are desired.

### BRIEF DESCRIPTION OF THE DRAWINGS

The accompanying drawings depict various example embodiments for illustrative purposes but are not to be construed as limiting the scope of later appended claims.

FIG. 1A-1D illustrate a Y-connector assembly with two ball valves are clamped to a Y-connector, with inlet and outlet on the same plane, according to some embodiments.

FIG. 2A illustrates a V-connector with bottom inlet, and two outlets at 90 degrees each being clamped to a severe service ball-valve, according to some embodiments.

FIG. 2B illustrates a 3D front view of the V-connector arrangement of FIG. 2A.

FIG. 3A illustrates a Y-connector with a ball-valve and a reducer between the Y-connector and the ball valve, according to some embodiments.

FIG. 3B illustrates a top perspective view of the Y-connector and ball-valve with intermediate reducer arrangement of FIG. 3A.

FIG. 4A illustrates an integrated Y-connector and reducer clamped to ball valves, according to some embodiments.

FIG. 4B illustrates a top perspective view of the integrated Y-connector and reducer with clamped ball valves arrangement of FIG. 4A.

FIG. 5A illustrates a Y-connector coupled to a ball-valve integrated with a reducer, according to some embodiments.

FIG. 5B shows a top perspective view of the Y-connector clamped to the ball-valve integrated reducer arrangement of FIG. 5A.

FIG. 6A illustrates a top view of an integrated Y-connector and reducer coupled to a ball-valve with a second reducer, according to some embodiments.

FIG. 6B is a 3D top perspective view of the integrated Y-connector and reducer coupled to a ball-valve with a second reducer arrangement of FIG. 6A.

FIG. 6C illustrates a top view of a Y-connector and a clamped reducer, coupled to a ball-valve with a second reducer, according to some embodiments.

FIG. 6D is a 3D top perspective view of the Y-connector and clamped reducer coupled to a ball-valve with a second reducer arrangement of FIG. 6C.

FIGS. 7A-7G illustrate a three-way ball valve, according to some embodiments.

FIG. 8A illustrates a top view of a Y-connector, reducer and Y-pattern globe valve arrangement, according to some example embodiments.

FIG. 8B is a 3D perspective view of the Y-connector, reducer and Y-pattern globe valve arrangement of FIG. 8A.

FIG. 9A illustrates a top view of an ebullated bed pressure let down skid, according to some embodiments.

FIG. 9B illustrates a perspective view of the skid shown in FIG. 9A.

FIG. 10A illustrates a top view of a Y-connector clamped to an integrated block of a first ball valve serially connected to a second ball valve, according to some embodiments.

FIG. 10B is a 3D perspective view of the Y-connector clamped to the two ball valve arrangement of FIG. 10A.

FIG. 11A illustrates a top view of an arrangement in which a Y-connector, reducer, a Y-pattern globe valve and a ball valve are serially arranged and clamped, according to some embodiments.

FIG. 11B is a 3D perspective view of the arrangement in which a Y-connector, reducer, a Y-pattern globe valve and a ball valve are serially arranged and clamped as shown in FIG. 12A.

FIG. 11C is a cross-section view of a Y-pattern globe valve that can be used in example embodiments, such as in the embodiments shown in FIG. 12A.

FIGS. 12A-12D show a skid including a thermal expansion pipe run preceding the control valve, according to some embodiments.

FIGS. 13A-13D show a skid including a thermal expansion pipe run including an extension that is diagonally arranged preceding the control valve, according to some embodiments.

FIGS. 14A-14D show a skid including a thermal expansion pipe run including an extension that is diagonally arranged preceding the control valve and in which the left and right input legs of the skid is offset with each other in the length direction, according to some embodiments.

### DETAILED DESCRIPTION OF EXAMPLE NON-LIMITING EMBODIMENTS

Example embodiments of the present disclosure provide modular skid arrangements, and, in particular, ebullated bed pressure let down skids (modular skids configured to connect to ebullated bed applications) that yield improved serviceability when compared to existing skids such as that described in the background section above, and, at least in some instances, skids that are more adaptable to thermal stress, more compact and/or more transportable. The skids in example embodiments may provide improved serviceability by enabling servicing of a control valve in the skid when maintenance is required by isolating and shutting down only that leg in which that valve resides while another leg of the skid continues to be available for fluid flow (also, interchangeably, “process flow”), rather than requiring all of the multiple legs to be inoperative as in the skid described in the background. In some instances, providing for valves to be serviced in-place in the skid without disconnecting the defective valve yields improved serviceability. Improved compactness and/or transportability are provided in some embodiments by the use of narrower (i.e., smaller diameter) piping and/or smaller valves, more compact valve and/or connector arrangements, etc.

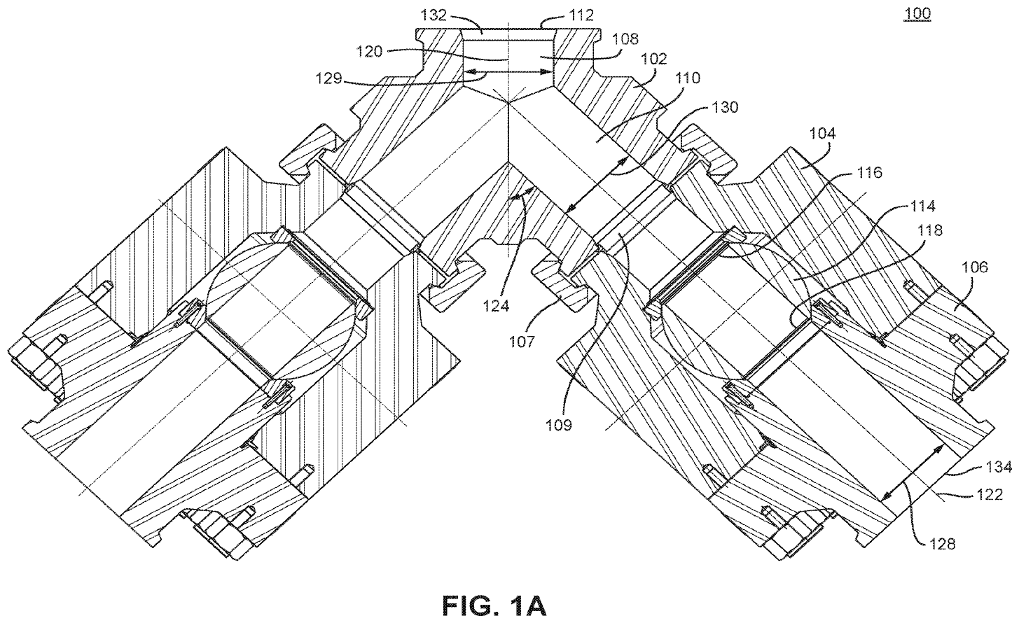

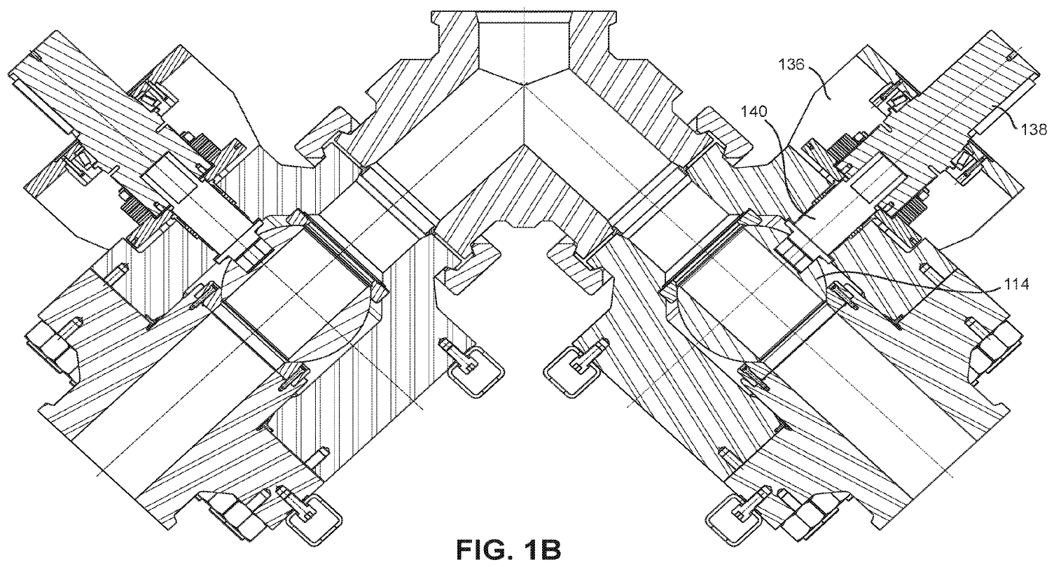

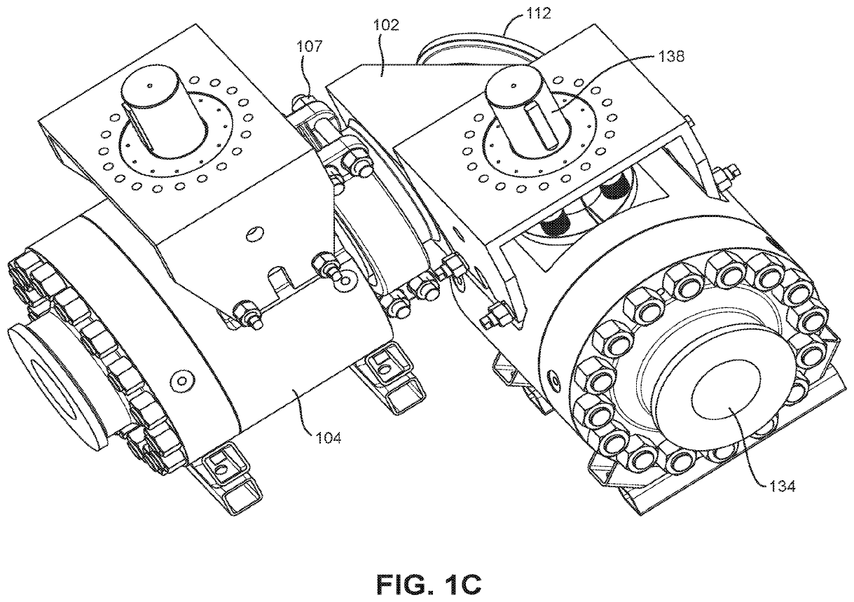

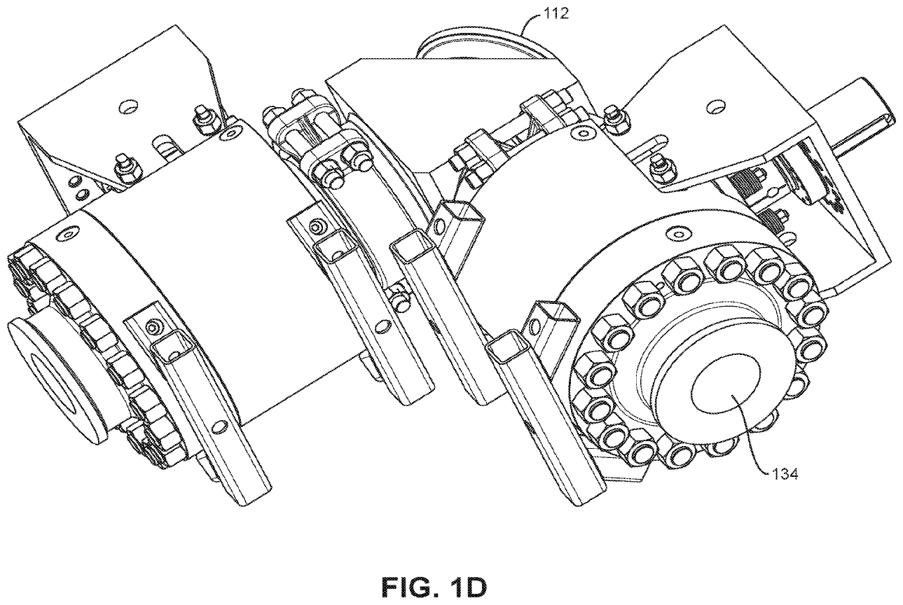

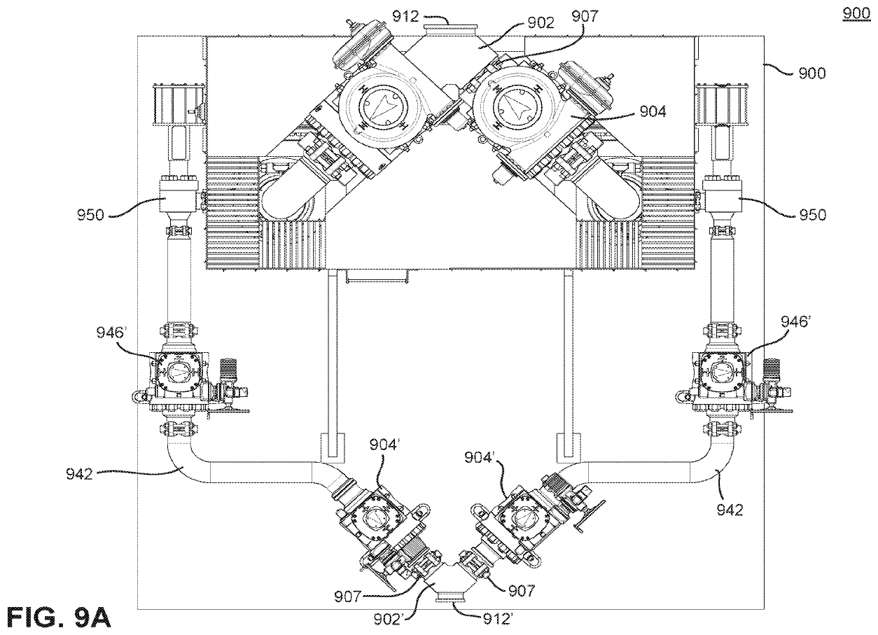

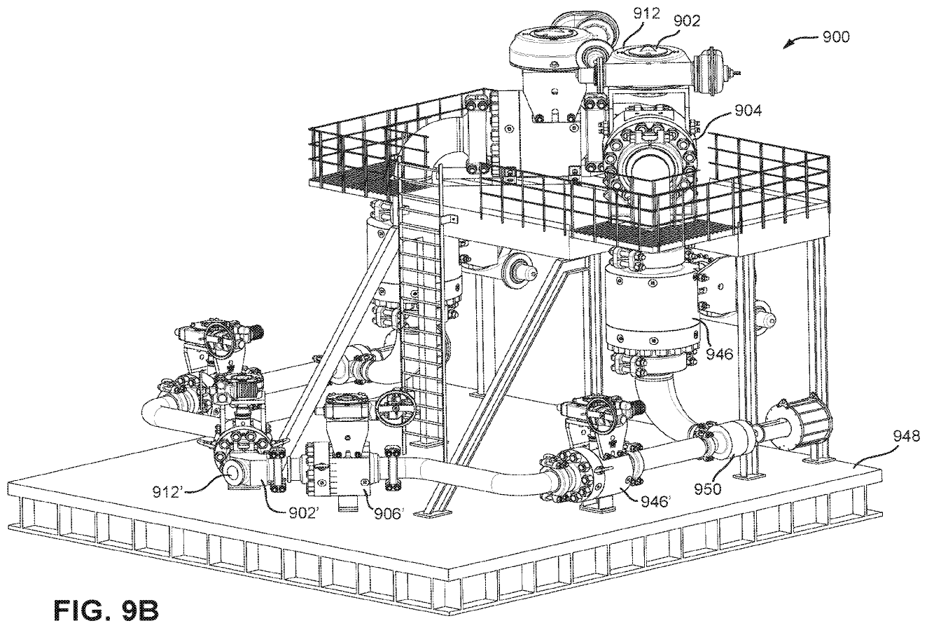

FIG. 1A illustrates a top view of a Y-connector assembly 100 with two ball valves clamped to a Y-connector, with inlet and outlet on the same plane, according to an embodiment. The Y-connector assembly 100 of can be used at the inlet and/or at the outlet of a pressure let down skid (e.g., Hot High Pressure Separator (HHPS) let down skid) in an ebullated bed (e.g., Ebullated Bed Hydrocracking Unit) such as that shown, for example, in FIGS. 9A and 9B.

The Y-connector assembly 100 includes a Y-connector block 102 and a ball valve block 104 that are clamped to each other with clamp 107. The use of the clamp 107 to connect the ball valve at connection point 109 to the Y-connector block 102 is designed to save space in the area nearest the fork in the Y-connector. The connection point 109, with the clamp 107, provides a metal-on-metal coupling of the Y-connector block 102 and a ball valve block 104. The other end of the ball valve block 104 is secured using flanged connector 106 and bolts.

The U.S. Pat. No. 9,366,347 describes a multiport manifold (illustrated as a Y-shaped connector) connected by bolts to a flange of the ball valves. (See FIG. 1 of U.S. Patent '347). In the multiport manifold of the '347 patent, in addition to having to remove the entire manifold (thus rendering the skid inoperative), the bolts used closer to the fork in the manifold reduces the available space in that area making it difficult for serviceability.

The clamp 107 is substantially smaller and occupies less space than the type of flanged bolted example in the '347 patent. In one embodiment, clamp 107 is a “Graylock® Connector” which features a metal-to-metal bore seal that is recognized as the standard for critical service piping. Compared to conventional ANSI or API ring joint flanges, the Grayloc® Connector is significantly lighter and smaller. The diameter of the clamp is less than that of a flange. The length of the weld neck is also shorter than that of a comparable flange, further reducing weight and space. The Grayloc® Connector allows components, such as valves, to be installed without regard to bolt hole alignment. The clamp may be rotated a full 360° around the hub to orient the bolts so the connectors can be assembled and disassembled in confined spaces with minimal clearance. At least the above identified four factors—smaller diameter, shorter length, freedom to rotate the clamp, and having no bolt hole alignment constraint—provide an opportunity to design lightweight compact systems when compared to the flanged-and-bolted systems such as the multiport manifold of U.S. Pat. No. 9,366,347.

According to an embodiment, the Y-connector block 102 comprises a main bore 108 in fluid communication with two transverse auxiliary bores 110, which correspond to the number of isolation valves 114, which in some embodiments are also referred to “ball valves”, that are to be coupled to the Y-connector block 102. In example embodiments an end connector 132 is secured to the inlet of the Y-connector block 102 for connection to a process line to supply or remove process fluid to or from the main bore 108. In the illustrated embodiment, the width of the main bore is the same as the width 130 of the auxiliary bores 110. However, in some embodiments, the width of the auxiliary bores 110 may be smaller than the width of the main bore 108.

In an embodiment, a central longitudinal axis 122 in each auxiliary bore 110 is arranged within Y-connector block 102 at an angle 124 of about 20° to about 60° (or 45° to about 90°) relative to the main bore central longitudinal axis 120. Each angle has two sides (or legs)—vertical (a) and horizontal (b). The more acute the angle, the more compact the skid envelope can be constructed. The more compact the skid can be, the less material costs will be associated with skid, including weight, etc. The more acute angle is, the more flow disruption can occur within the bores. 90-degree angles will have most disruption to flow ‘smoothness’, less flow rate capacity which can increase pipe size (flow path size) to obtain output capacity required.

In example embodiments, each ball valve block 104 comprises a bore with a valve cavity formed at an intermediate location in the bore. The bore width 128 may be the same as the width 129 of the main bore 108, or the width 130 of the auxiliary bores 110 of the Y-connector. The ball valve 114 controls fluid flow through the valve cavity. The ball valve 114 is rotatable by valve control stem elements 136, 138 and 140 (FIG. 1B) such that the proportion of the width of the bore being sealed at valve seats 116, 118 by the ball valve 114 is controllable. The sealing made at the valve seats by the ball valve 114 is a metal-to-metal sealing contact.

In an embodiment, the spacing from the main bore central longitudinal axis 120 to the ball valve block 104 is less than the clear space required for an equivalently rated flange connection according to ANSI B16.10 or an equivalent thereof, based on the inner diameter of the bore and the pressure/temperature rating of the severe service ball valve. In contrast to bolt arrangements for securing the ball valve block to the Y-connector block, the clamp 107 in example embodiments, provides for sufficient space for access for assembly and/or disassembly.

FIG. 1B also shows a control stem arrangement 136 that, in a lower end. attaches to the ball of the ball valve114, to control the sealing of the bore at seats 116, 118. The ball valve 114 and the associated control stem arrangement 136 may be a known ball valve arrangement, for example, and without limitation. the “Securaseal metal-seated ball valves”™, such as that described in https://www.velan.com/en/products.

When the Y-and connector assembly 100 is used at the inlet of an arrangement such as, for example, the skid 900 (see FIGS. 9A and 9B), the fluid flow enters at inlet 112 and, when both severe service ball valves 114 are in the open state, flows out of the two outlets 134. When used at the outlet of an arrangement such as the skid 900, the fluid flow enters through 134 of the auxiliary bores and exits the main bore at 112. However, for convenience, the opening 112 is referred to as the inlet and the openings 134 are referred to as outlets.

FIG. 1B shows a cross-section view of the Y-assembly 100. A stem control arrangement 136, 138 and 140 to control the ball valve 114 is illustrated in FIG. 1B.

FIG. 1C shows a 3D top perspective view of the Y-assembly 100 in accordance with an embodiment. FIG. 1D shows a 3D bottom perspective view of the Y-assembly 100 in accordance with an embodiment. As can be seen, the inlet 112 and the outlets 134 of the assembly 100 are on the same plane.

In some embodiments, in addition to the inlet 112 and the illustrated outlets 134, a side outlet (not shown) may be included in the Y-connector block 102. A side outlet may be used, for example, to provide a bypass, and in some embodiments may help alleviate thermal stress.

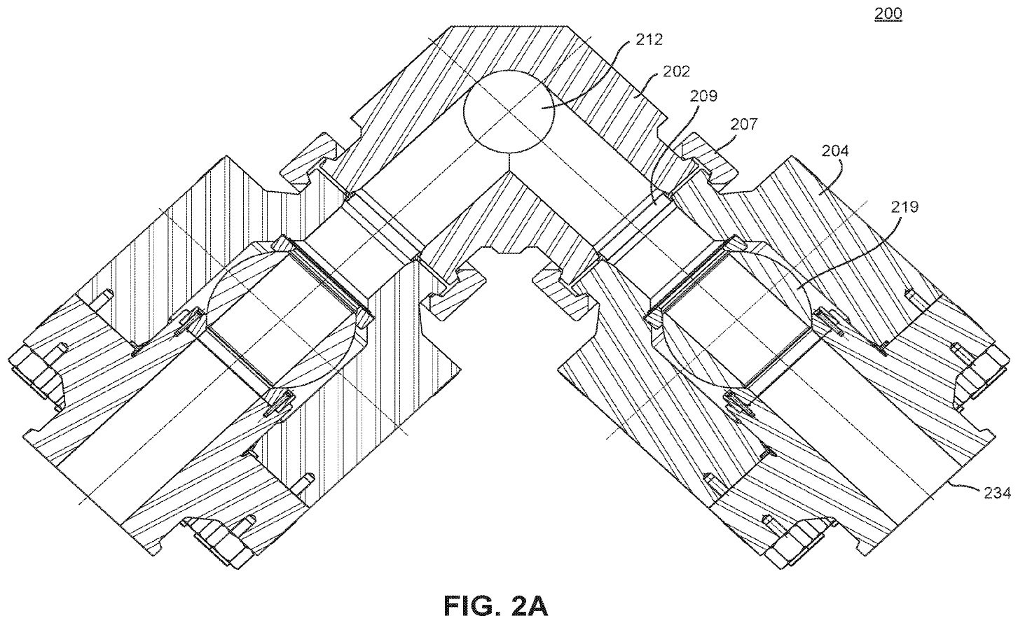

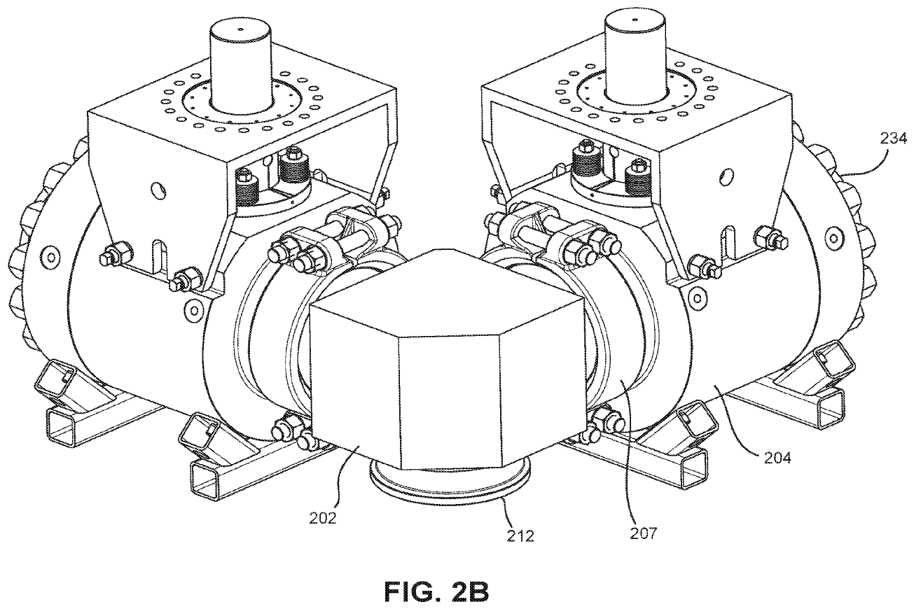

FIG. 2A illustrates a V-connector with bottom inlet, and two outlets at 90 degrees each being clamped to a severe service ball-valve, according to an embodiment. The V-connector arrangement 200 can be used at the inlet and/or the outlet of an ebullated bed pressure let down skid such as that shown, for example, in FIGS. 9A and 9B.

In contrast to the Y-assembly arrangement 100 shown in FIG. 1A which has the inlet on the same plane as the outlets, the bottom view of V-connector assembly 200 illustrates the inlet 212 being located so that a process line attaches to the bottom of assembly 200. The location of the inlet 212 at the bottom of assembly 200 offers space savings because the process line connection is not required to extend beyond the V-connector block 202, and can overlap partly or fully with the space occupied by the V-connector on the skid (e.g., a skid similar to skid 900). Adding one or more elbows on a straight pipe provides more flexibility in the longitudinal axis since the pipe can now bend naturally around these elbows. Hence having the inlet and outlet in different planes from each other will automatically reduce thermal stresses by providing additional flexibility. For a top-down inlet, there may be feed (booster) pumps to move media from one equipment to another (“feed” is another term used to describe the “media” inside the pipelines). In some embodiments, to utilize gravity as a positive factor, the flow inlet can be positioned so that the line coming from pump to the skid is from top position to bottom inlet in the assembly 200. By making the assembly 200 smaller, more compact, the overall length of the skid is reduced, thus impacting thermal growth of materials and related thermal stresses. Thermal expansion (growth) is a direction function to unit of length.

In example embodiments, the ball valve block 204, the ball valve 219, connection point 209, clamp 207, and outlet 234 of the arrangement 200 may be similar to the ball valve block 104, the ball valve 114, connection point 109, clamp 107, and outlet 134 described above in relation to the arrangement 100.

FIG. 2B illustrates a 3D front view of the V-connector arrangement 200, showing the inlet 212 in the vertical plane and the outlets 234 in the horizontal plane.

In some embodiments, the plane of the inlet in assembly 200 may not be at a right angle with the plane of the outlets, and may be at an angle different (+/−45 degrees) from the right angle.

In some embodiments, in addition to the inlet 212 and the illustrated outlets 234, a side outlet (not shown) may be included in the V-connector block 202. A side outlet may be used, for example, to provide a bypass, and may help alleviate thermal stress.

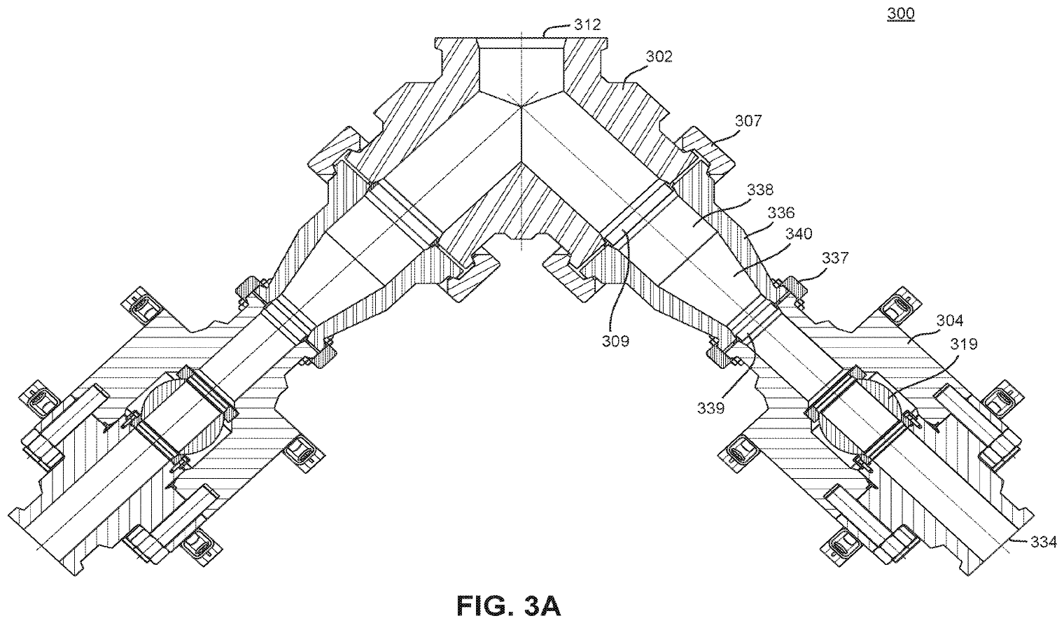

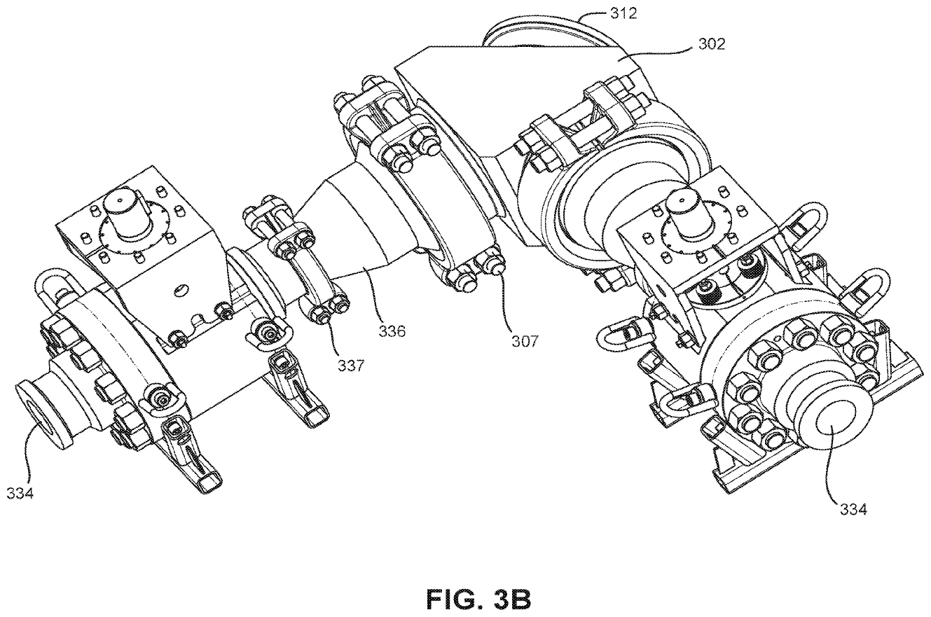

FIGS. 3A-6B illustrate example embodiments in which one or more reducers are integrated with, or otherwise incorporated to, various connector and isolation valve assemblies. Reducers provide for stepping down from a larger width pipe bore to a smaller width pipe bore, and thus, can substantially affect the weight and cost of the piping on a skid. While example embodiments provide for locating reducers near the inlet, they also provide for corresponding expanders to be located near the outlet, thereby increasing the amount of piping on the skid that can be at a narrower width than the main bore. One of the main challenges is to run flow calculations to ensure that the new flow conditions are acceptable with respect to the desired capacity of the skid. By locating the reducer at the beginning of the skid, for example, the downstream equipment from this point is reduced in size, thus creating an economical value to the overall costs/price of skid.

FIG. 3A illustrates a Y-connector with a ball-valve and a reducer between the Y-connector and the ball valve, according to some embodiments. The Y-connector and ball-valve with intermediate reducer arrangement 300 can be used at the inlet and/or outlet of an ebullated bed pressure let down skid such as that shown, for example, in FIGS. 9A and 9B.

In an embodiment, the arrangement 300 provides an 18-to-10 (inches) reducer 336 before the two isolation valves (i.e., before the first isolation valve 314) after the inlet 312 on each path, and in some instances, after the last isolation valve (not shown) but before the outlet 334 on each path. The reducer 336 changes from a larger width bore 338 to a smaller width bore 340.

In conventional skids, the reducer is usually placed after the isolation valves (e.g., valves 904 and 946 in skid 900) very shortly before the control valve (e.g., valve 950 in skid 900). The example embodiment shown in FIG. 3A relocated the reducer 336 to be between the first isolation valve 304 and the Y-connector 302, attached using clamps 307 and 337. This allows the use of smaller isolation valves and also reduces the required width of a substantial proportion of the piping, thus making the overall assembly more compact and lowering cost.

In example embodiments, the ball valve block 304, the ball valve 319, connection point 309, clamp 307, and outlet 334 of the arrangement 300 may be similar to the ball valve block 104, the ball valve 114, connection point 109, clamp 107, and outlet 134 described above in relation to the arrangement 100. Moreover, the connection at connection point 339 and clamp 337 may be similar to the connection at connection point 309 and clamp 307, respectively, other than for the differences in the width of the respective bores.

FIG. 3B illustrates a top perspective view of the Y-connector and ball-valve with intermediate reducer arrangement 300 shown in FIG. 3A.

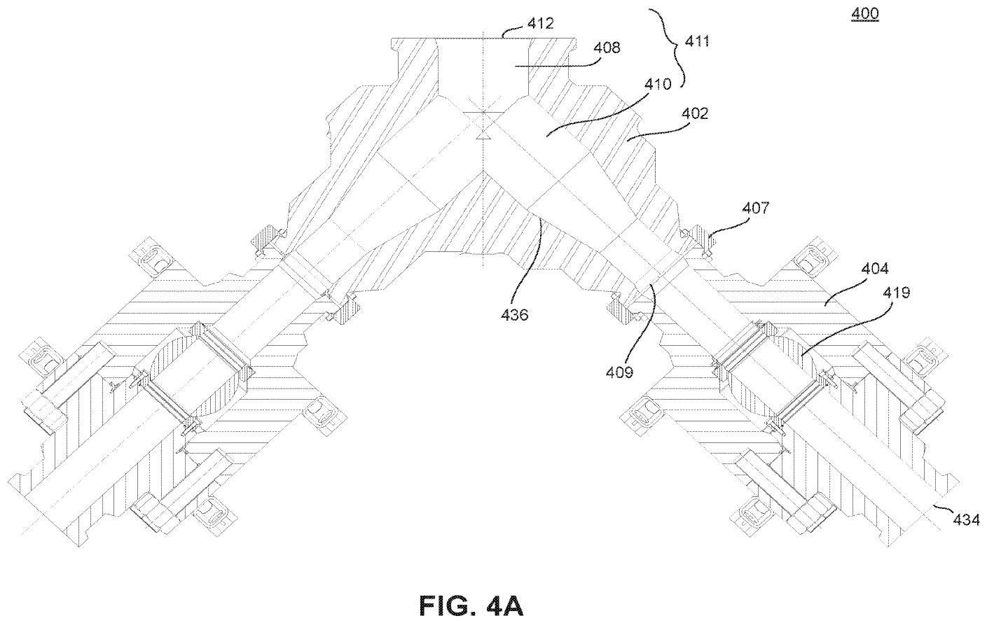

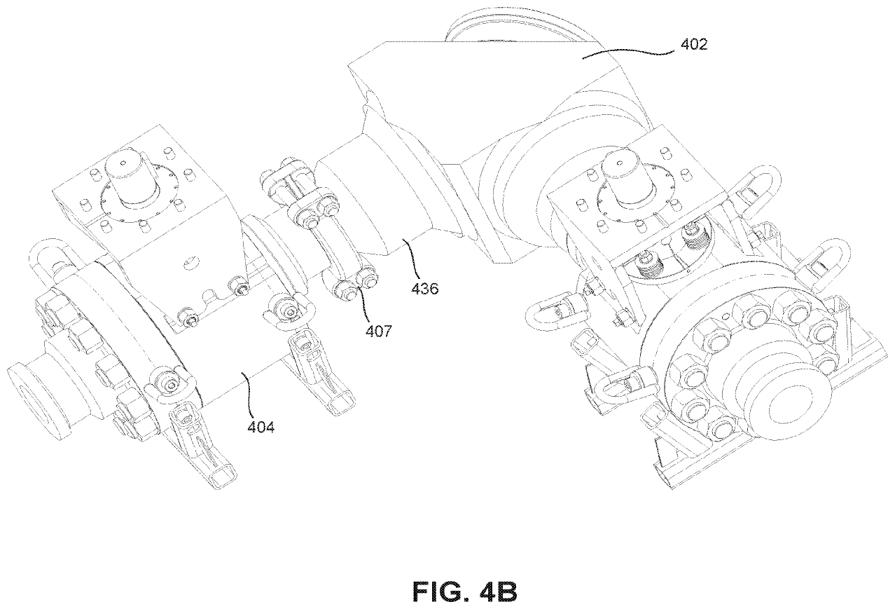

FIG. 4A illustrates an integrated Y-connector and reducer clamped to ball valves, according to some embodiments. The integrated Y-connector and reducer with clamped ball valves arrangement 400 can be used at the inlet and/or outlet of an ebullated bed pressure let down skid such as that shown, for example, in FIGS. 9A and 9B.

In arrangement 400, an integrated block 402 includes the reducer 436 directly with the Y-connector 411. This would further reduce the size of overall assembly than in the arrangement 300 (FIG. 3A) in which the reducer and the Y-connector are discrete modules and are connected by an intermediate clamp. The integrated block 402 requires one less clamp (than in the arrangement 300) in connecting the ball valve block 404, and consequently promotes space savings, ease of assembly and lower cost.

In example embodiments, the ball valve block 404, the ball valve 419, connection point 409, clamp 407, and outlet 434 of the arrangement 400 may be similar to the ball valve block 104, the ball valve 114, connection point 109, clamp 107, and outlet 134 described above in relation to the arrangement 100. The connection at connection point 409 and clamp 407 may be similar to the connection at connection point 109 and clamp 107, respectively, other than for the differences in the width of the respective bores.

FIG. 4B illustrates a top perspective view of the integrated Y-connector and reducer with clamped ball valves arrangement 400.

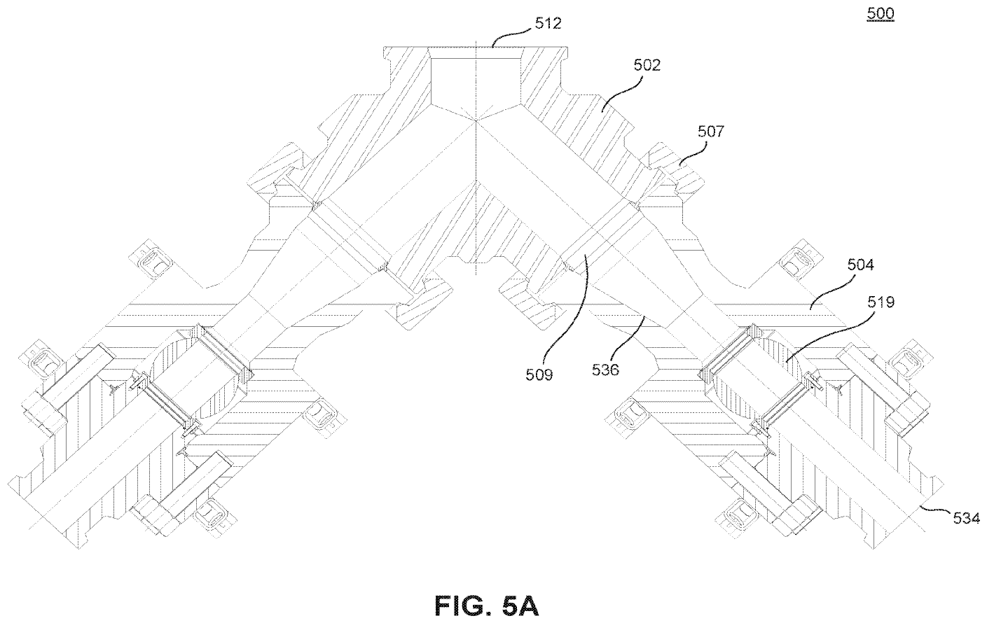

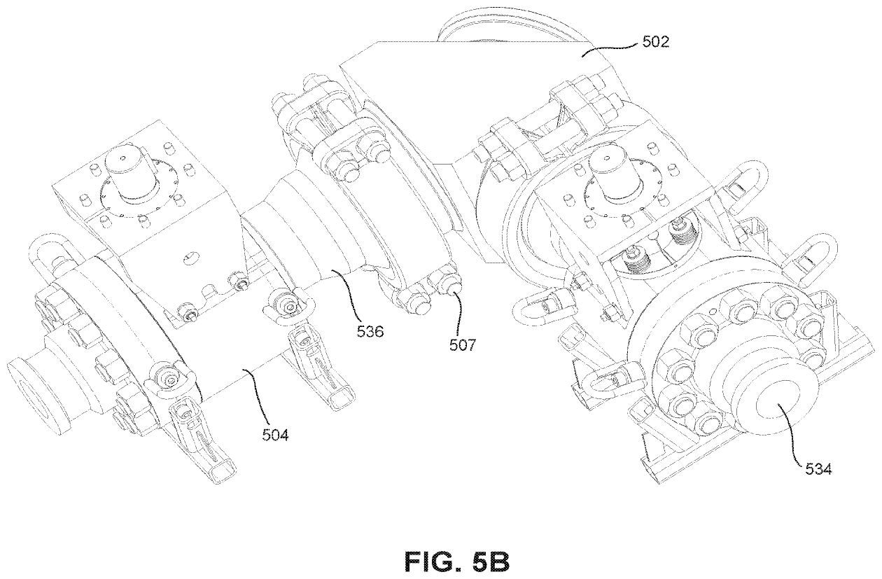

FIG. 5A illustrates a Y-connector coupled to a ball-valve integrated with a reducer, according to some embodiments. The Y-connector clamped to the ball-valve integrated reducer arrangement 500 can be used at the inlet and/or outlet of an ebullated bed pressure let down skid such as that shown, for example, in FIGS. 9A and 9B.

Instead of integrating the reducer with the Y-connector as in the arrangement 400 (FIG. 4A), arrangement 500 integrates the reducer 536 with the ball valve block 504. This arrangement would also use only one set of clamps (i.e., 507 at connection point 509) to connect the Y-connector block 502 and the integrated reducer and ball valve block 504 which would make the assembly compact and lower cost for similar reasons as described in relation to FIG. 4A. However, the clamps used in this arrangement would be larger than those used in arrangement 400 and hence would likely be slightly less efficient in cost, weight and space use than arrangement 400.

In example embodiments, the Y-connector block 502, the ball valve 519, connection point 509, clamp 507, and outlet 534 of the arrangement 500 may be similar to the Y-connector block 102, the ball valve 114, connection point 109, clamp 107, and outlet 134 described above in relation to the arrangement 100.

FIG. 5B shows a top perspective view of the Y-connector clamped to the ball-valve integrated reducer arrangement 500.

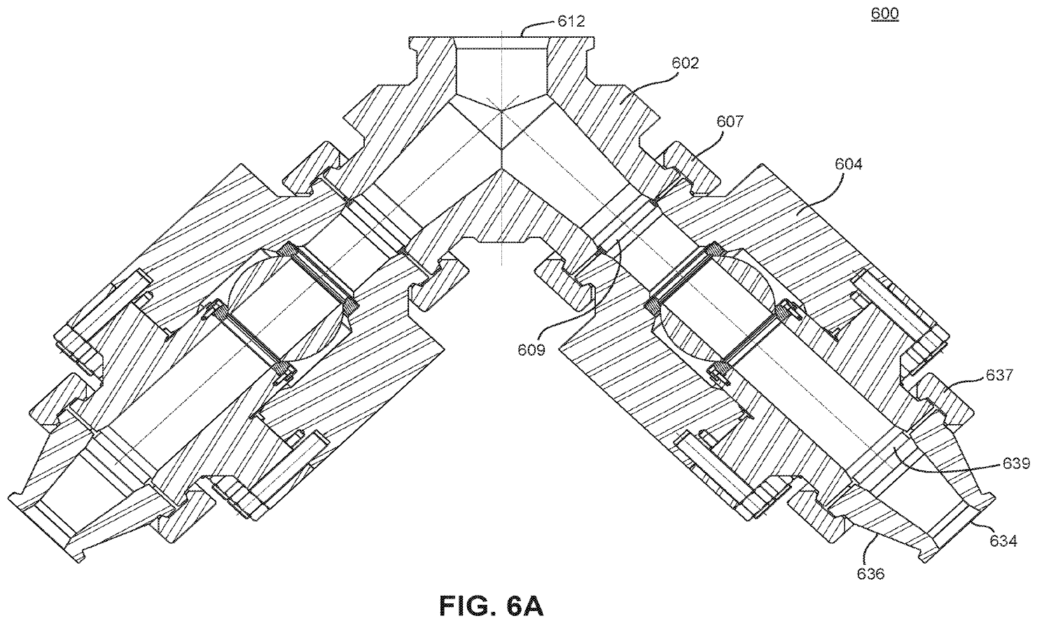

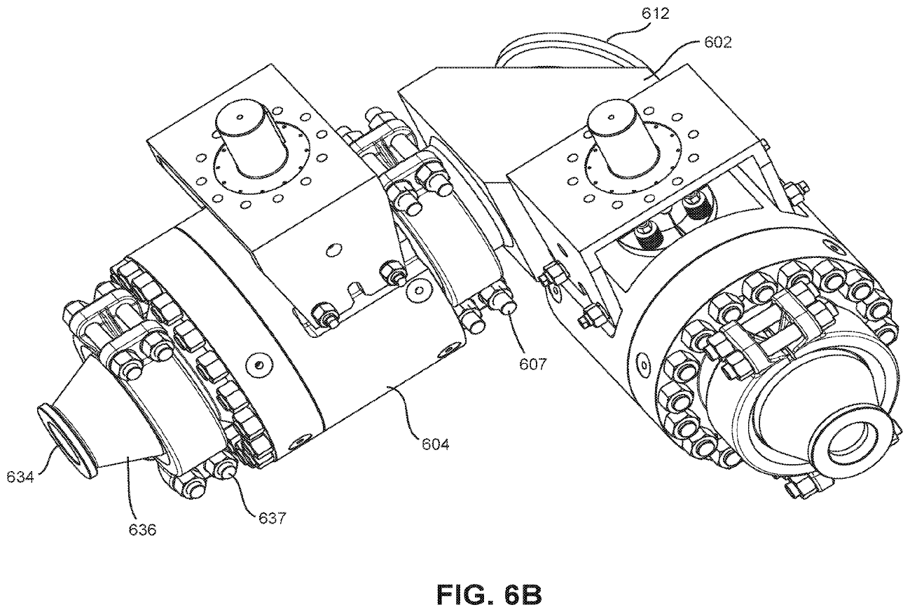

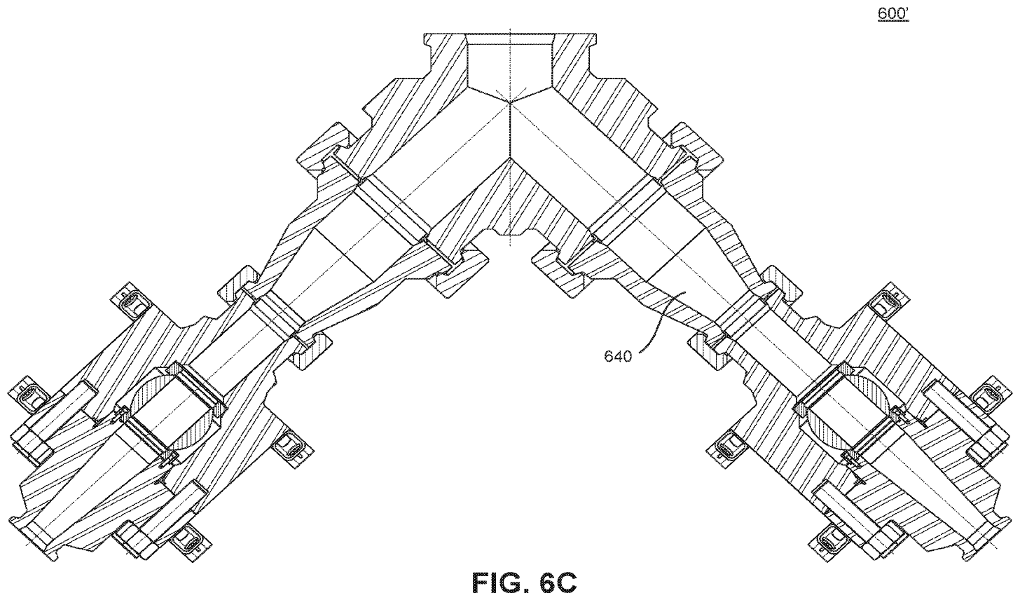

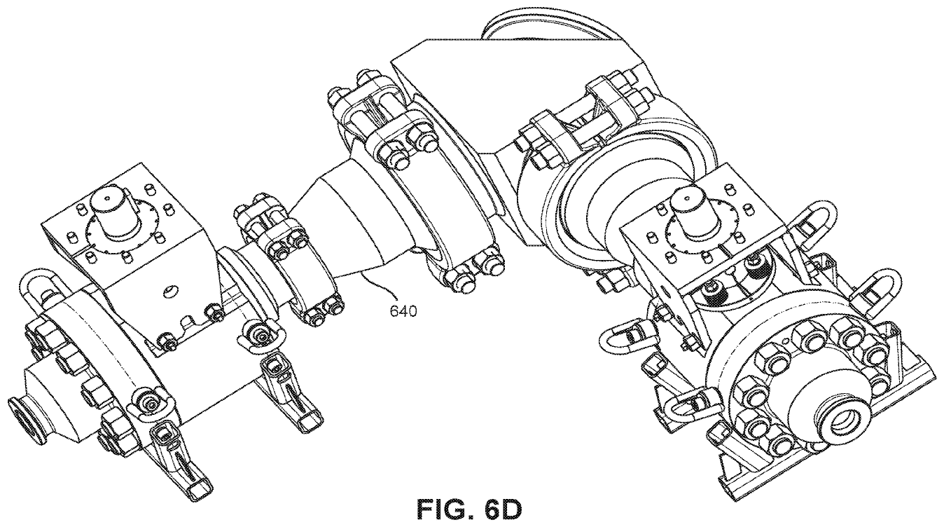

FIG. 6A illustrates a top view of an integrated Y-connector and reducer coupled to a ball-valve and a second reducer, according to some embodiments. The integrated Y-connector and reducer coupled to a ball-valve with a second reducer arrangement 600 can be used at the inlet and/or outlet of an ebullated bed pressure let down skid such as that shown, for example, in FIGS. 9A and 9B.

In some configurations, using one reducer might result in too drastic a change in pipe width for large size differences. In such cases, the width can be reduced in two stages as shown in the arrangement 600. A first reduction is accomplished through a reducer integrated with the Y-connector in a single block 602 which would be clamped (e.g., clamp 607 at connection point 609) to the ball valve block 604 as in the arrangement 400 (FIG. 4A). Then a second reduction is accomplished through a second reducer 636 clamped (e.g., clamp 637 at connection point 639) to the ball valve block 604 exit. Similar to arrangements 300-500, this arrangement 600 too would make the overall assembly less expensive than conventional skid arrangements because of the increased use of smaller pipes.

In example embodiments, the ball valve block 604, the ball valve 619, connection point 609, clamp 607, and outlet 634 of the arrangement 600 may be similar to the ball valve block 104, the ball valve 114, connection point 109, clamp 107, and outlet 134 described above in relation to the arrangement 100. Moreover, clamp 637 and connection point 639 may be similar to clamp 607 and connection point 609, respectively.

FIG. 6B is a top perspective view of the arrangement 600 in which the integrated Y-connector and reducer block 602 is coupled to the ball-valve block 604 which is coupled further to a second reducer 636.

FIG. 6C illustrates a top view of an arrangement 600′ in which a first reducer 640 is clamped between the Y-connector and a ball valve block with an integrated second reducer at the outlet.

FIG. 6D is a top perspective view of the arrangement of FIG. 6C.

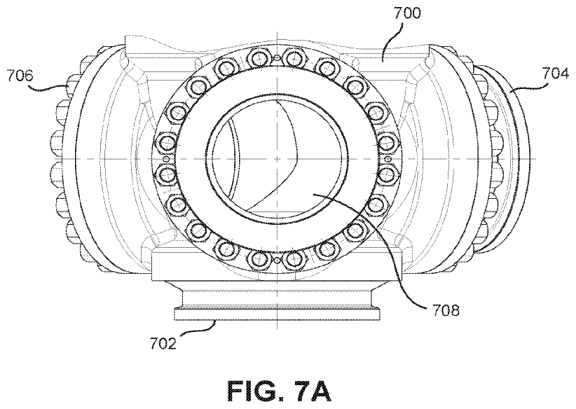

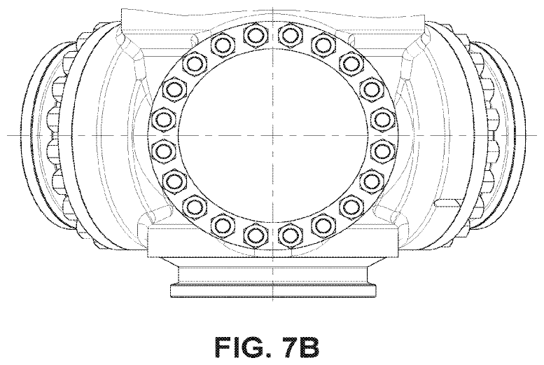

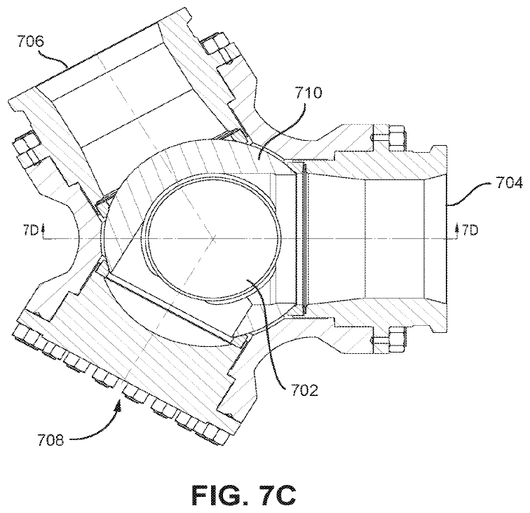

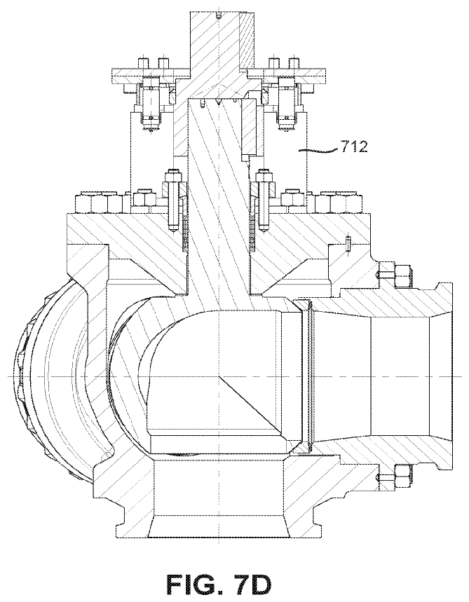

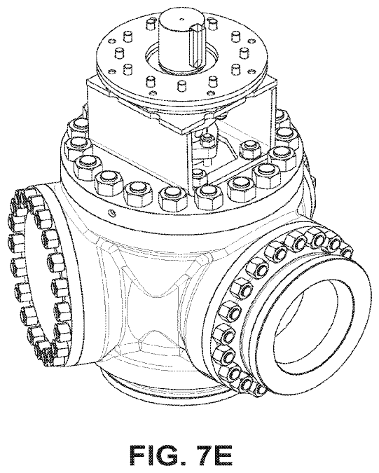

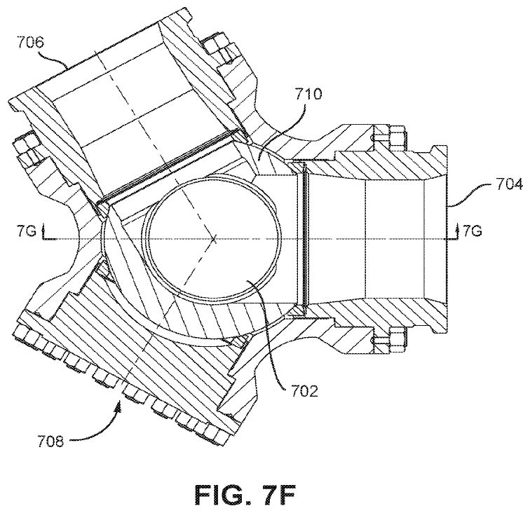

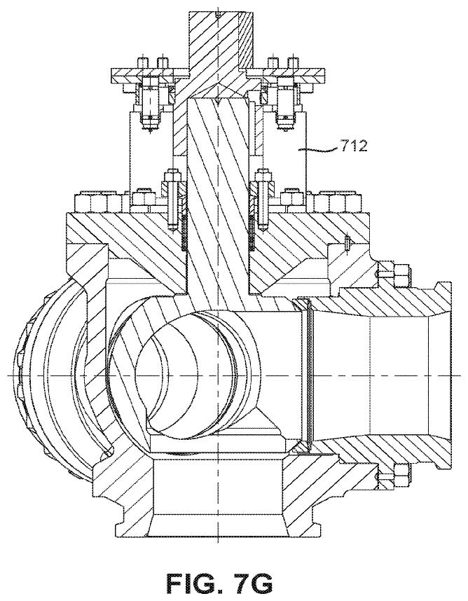

FIGS. 7A-7E illustrates a three-way ball valve, according to some embodiments. The three-way ball valve 700 can be used at the inlet and/or the outlet of a skid. In an example skid, such as, for example, the skid 900, the three-way ball valve 700 can replace the Y-connector with clamped severe service ball valves that are shown at the inlet and outlet of skid 900.

In some embodiments, the three-way ball valve 700 provides a unitary device having one valve to select a path from among the plurality of pathways on the skid. In the example three-way ball valve 700, comprises a bottom inlet 702 and three outlets 704, 706 and 708 which are distributed in equal angles around the vertical axis of the valve 700. In some embodiments, the angles between outlets 704, 706, 708 may not be equal.

In some embodiments, a larger ball 710 (FIG. 7C) with 2 ports may be used in the valve in order to flow two legs simultaneously. In example embodiments, the inlet 702 diameter may be the same as, or may be different than, the outlet diameter of outlets 704, 706 and 708.

The bottom inlet 702 is configured to reduce thermal stresses, and the third outlet (i.e. one of 704, 706, 708) can be used for either bypass or a third leg for fluid flow. Adding one or more elbows on a straight pipe provides more flexibility in the longitudinal axis since the pipe can now bend naturally around these elbows. Hence having the inlet (i.e. bottom inlet 702) and outlet in different planes would automatically reduce thermal stresses on the piping by providing additional flexibility. FIGS. 7F and 7G show a configuration in which two outlets are enabled.

Moreover, in some embodiments, the valve 700 provides top-entry to perform maintenance without valve removal from piping. For example, the actuator arrangement 712 (FIG. 7D) can be removed to access the ball (see FIG. 7C, 710) for maintenance.

In example embodiments, the three-way ball valve 700 can be incorporated with two additional isolation valves (e.g., ball valves or globe valves), as required by the application. For example, in one configuration, ball valves are clamped to at least two of the outlets 704, 706 and 708, so that the process flow can be independently controlled on respective legs of an arrangement such as a skid similar to that shown in FIG. 9A-9B.

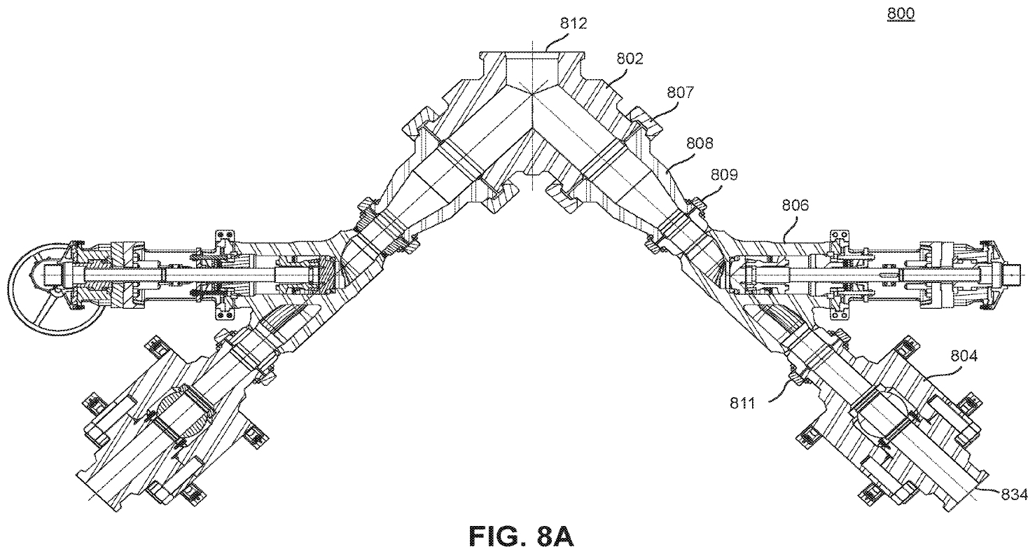

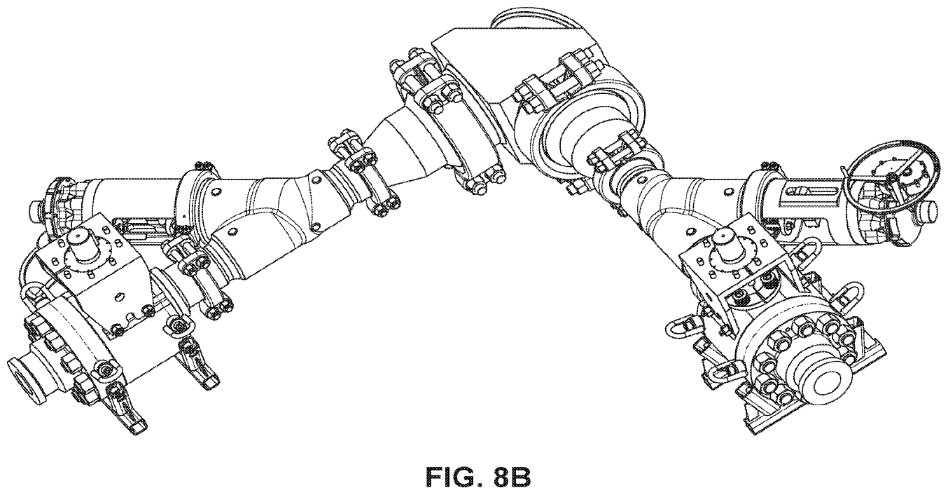

FIG. 8A illustrates a top view of a Y-connector, reducer and Y-pattern globe valve arrangement 800, according to some example embodiments. The Y-connector, reducer and Y-pattern globe valve arrangement 800 can, according to some embodiments, be used at the inlet and/or outlet of a skid such as skid 900 described below.

The Y-pattern globe valve 806 can, in some embodiments, replace one or both the ball-valves on a leg of the skid. The Y-pattern globe valve 806 may be a top-entry valve in that it can be accessed from the top without removing the valve as in the case of the Y-valve described in the background section of this disclosure.

In the arrangement 800, a Y-connector 802 is clamped (using clamp 807) to a reducer 808. At the other end of the reducer, a second clamp 809 connects to a Y-pattern globe valve 806. A third clamp connects the globe valve 806 to a ball valve 804. This arrangement 800 provides for both a globe valve 806 and a ball valve 804 in each process line of a skid, thus enabling each type of valve to be used in an advantageous manner to improve the function of the skid.

For use in skids like skid 900, the Y-pattern globe valve is constructed for pressure levels, thermal levels, etc. that enables its use in severe service. Globe valves are in-line serviceable which improve the serviceability of the skids. In addition, they are also torque-seated, meaning that one can apply more torque to improve sealing. Therefore they can provide a tighter seal over time, especially when sealing surfaces are getting worn.

FIG. 8B is a 3D perspective view of the Y-connector, reducer and Y-pattern globe valve arrangement of FIG. 8A.

In some example embodiments, all ball valves in a skid, such as skid 900, are replaced with Y-pattern globe valves. In some other embodiments, only some of the ball valves are replaced with Y-pattern globe valves. For example, as shown in FIGS. 8A and 8B, a Y-pattern globe valve can be used for the first isolation valve (e.g., valve 904 in skid 900) and a severe service ball valve can be used for the second isolation valve (e.g., valve 946 in skid 900). In contrast to the ball valves described above, the Y-pattern valve, a.k.a. Coker switch valve (SV) (e.g., High Pressure Switch Valve (HPSV) manufactured by Velan) can sometimes be linked to communication protocol (e.g., PLC) and direct or redirect process flow by utilizing only one HPSV equipment to do so. Thus in some configurations, instead of the ball valves reducing or increasing flow, the HPSV may be configured to become the master flow control valve.

FIGS. 9A and 9B illustrates an ebullated pressure let down skid 900 incorporating the Y-connector with clamped severe service ball valves as shown in FIGS. 1A-1D for the inlet and outlet, according to an example embodiment. In some example embodiments, the ebullated bed 900 is designed and configured for use in a process for cracking oil. The skid is typically used to control which of the control valves of the skid to use.

In this disclosure, the terms “process flow” and “fluid flow” are used interchangeably and are defined as the media flowing thru conduit. Media can be in forms/types: gaseous, liquid, or solids or any combination of the three. For the specific application of hydrocarbon cracking, inlet media is hot liquid (heavy hydrocarbons) and after going thru the control valve, it changes state to liquid and gas, which can be referred to as “two phase flow”.

In an ebullated bed process there are several locations where there must be pressure let down stations where the flow of the oil being cut can be controlled. Instead of building these pressure let down stations on-site, in some instances these stations are preassembled remotely from the site on a skid and transported as a module to the site.

The skid is typically used to isolate a control valve that requires maintenance without shutting down the process. Towards this end, the skid has multiple redundant flow paths from inlet to outlet with a control valve on each flow path. The skid contains at least two separate process lines (sometimes referred to as Train A and Train B) that each contains isolation valves and control valves. In some skids, each of the multiple paths is identical to the other paths. The skid is typically used to control process flow and allow maintenance of control valves by isolating the control valves for maintenance using the isolation valves. One train can be in maintenance mode while the other train can be online (in operation).

Depending on the use case, during operation, either one line will be used while the other line stays idle (e.g., hot line, cold line), or alternatively both lines will be used concurrently but since the process load that is designed to be sent on one line is being distributed to two lines, the pressure/thermal stress imposed is lessened.

FIG. 9A illustrates a top view of the ebullated pressure let down skid 900. At the inlet 912 of the skid 900, a Y-connector 902 is connected to a severe service ball valve 904 on each leg of the Y-connector 902 with a clamp 907. The same arrangement is also used for the outlet 912′. At the outlet 912′, the Y-connector 902′ is connected to a severe service ball valve 904′ on each leg with a clamp 907′.

Between the inlet Y-connector 902 and the outlet Y-connector 902′ two redundant fluid flow paths 942 formed with fluid flow devices including pipes and valves. On each of the redundant paths 942 a control valve 950 is used to regulate the flow.

FIG. 9B illustrates a perspective view of the skid 900. The skid 900 can be considered as one module comprising the platform 948, the fluid flow devices shown in FIGS. 9A and 9B, and other devices forming the arrangement constructed on the platform 948.

As described above, the redundant paths 942 provide for the ebullated pressure let down skid 900 to remain in service while one of its severe service ball valves 904 is being services and/or replaced.

According to come embodiments, the skid is assembled remotely from the deployment site, and the entire skid 900 as a module is transported to the deployment site.

According to some embodiments, the skid is about 3.5 meters in width, 7.5 meters in length and is about (no more than) two stories tall.

In skids such as that shown in FIG. 9A-9B, thermal stress on the piping may occur due to, among other things, one leg being hot while the other leg is cold. The hot side can expand and sometime has been observed to extend up to 14 inches in some instances. When such expansion occurs, the difference in leg lengths between the hot leg and the cold leg can impose a substantial amount of thermal stress on piping.

In some example embodiments, one or more ball-joints may be included connecting piping segments between the inlet and the outlet on each redundant fluid flow paths. Ball-joints used in example embodiments are manufactured for pressure levels, thermal levels, and sizes. The one or more ball-joints in each path are configured to allow the piping to move in order to accommodate thermal stress.

In some embodiments, the one or more ball-joints are arranged in the piping. In some other embodiments, the ball-joints are incorporated into the connector (e.g., the above described Y-connector arrangements, V-connection arrangement, or the three-way ball valve) at the inlet and/or outlet.

In some embodiments, a three ball-joint arrangement forming a swivel joint may be located on each leg of the skid between the inlet and the control valve such that a thermal-related expansion on one of the legs can allow the piping to move in a scissor-like manner, thus reducing the effects of the thermal stresses.

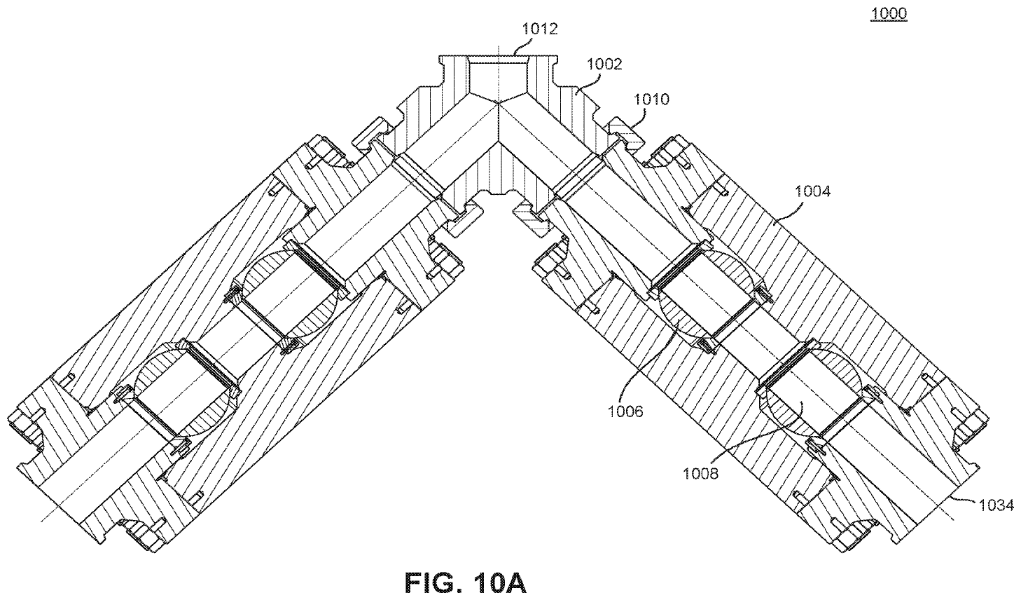

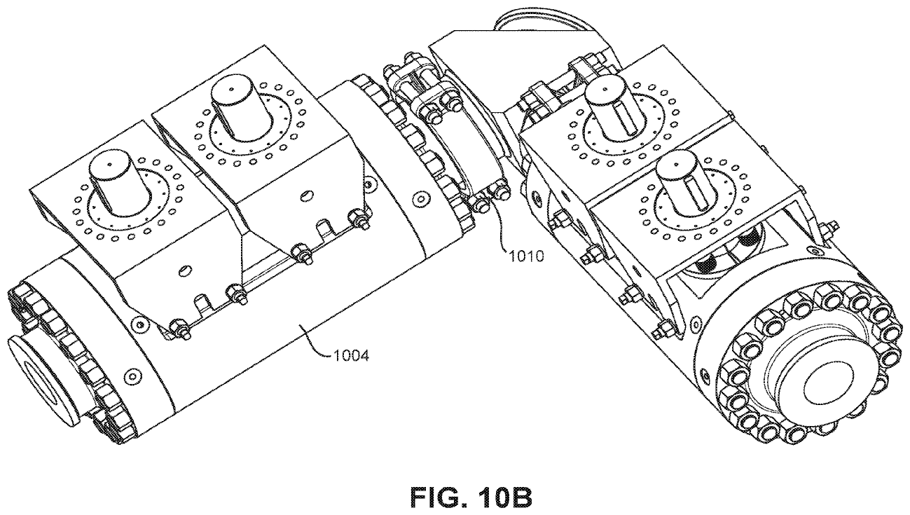

FIG. 10A illustrates an arrangement including a Y-connector and an integrated block with two ball valves. In the arrangement 1000, the Y-connector block 1002 is clamped, using clamp 1010, to the two ball valve integrated block 1004. The ball valves 1006 and 1008 are integrated, and thus the configuration reduces at least one clamp that is conventionally used between two ball valves in a skid. The arrangement 1000 can be used in a skid (e.g., skid 900) at the inlet and/or outlet of the skid. For example, the inlet 1012 can be at the inlet and/or outlet of the skid. Each of the two ball valves may operate as a respective isolation valve.

FIG. 10B illustrates a top perspective view of the arrangement 1000.

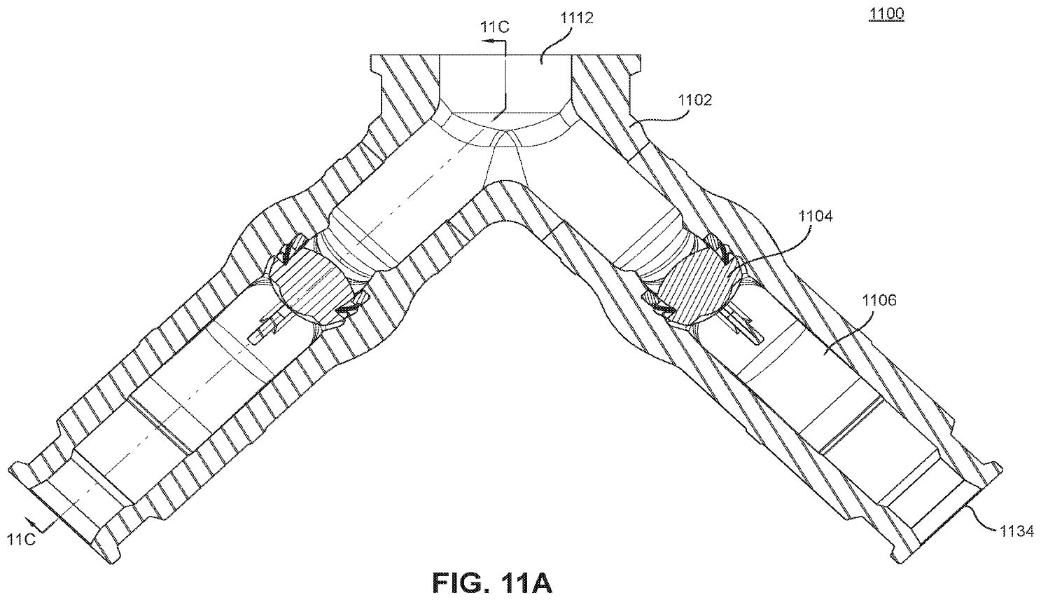

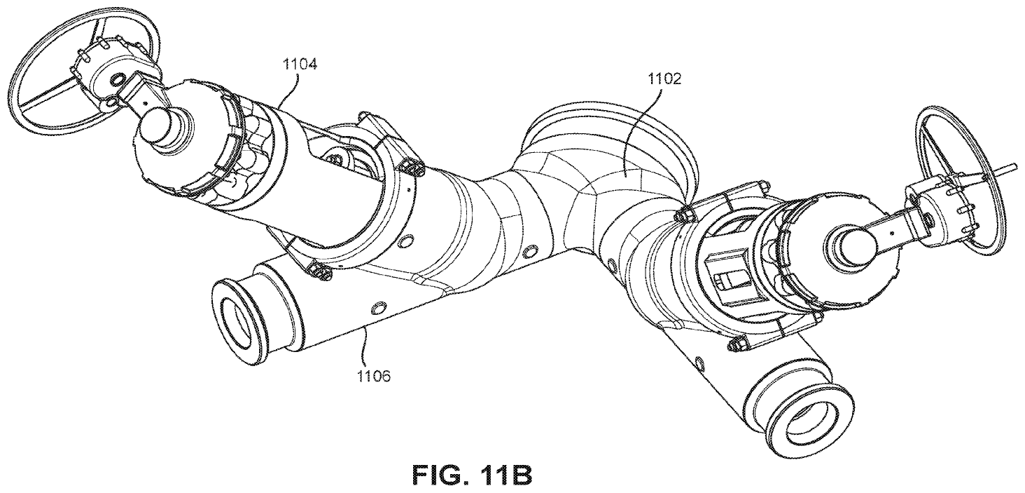

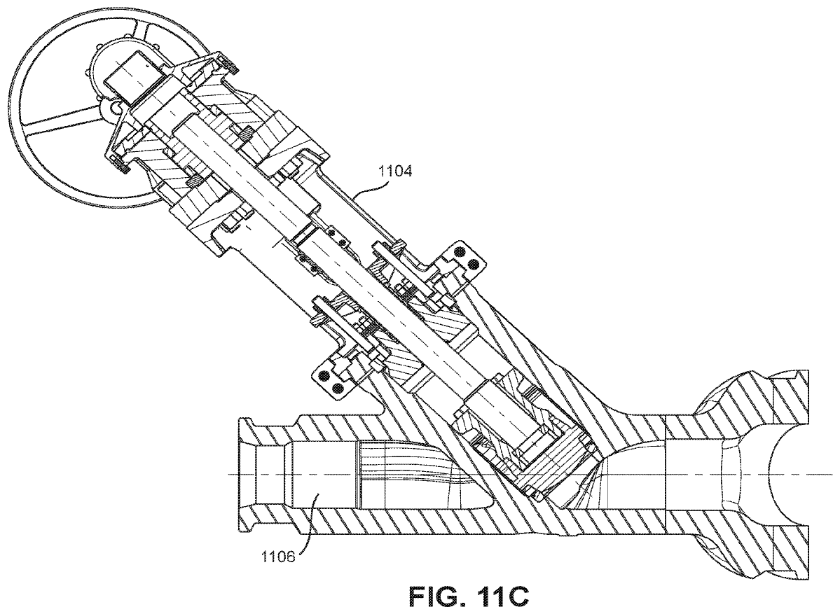

FIG. 11A illustrates an arrangement 1100 in which a Y-connector is integrated with a Y-pattern globe valve 1204 in each leg within a single integrated block 1102. In the illustrated arrangement, the Y-connector piping before the Y-pattern valve 1104 and the piping 1106 after that are the same width, but embodiments can include one or more reducers arranged before and/or after the valve 1104. There can be some advantages in this configuration: less clamps and seals (e.g., suppressing 2 clamp connection reduces the risk of leakage); and having a custom 1-piece body may be more compact that having 2 valves clamped on a Y-connector.

FIG. 11B illustrates a top perspective view of the arrangement 1100.

FIG. 11C illustrates a cross-section view of the Y-pattern globe valve 1204.

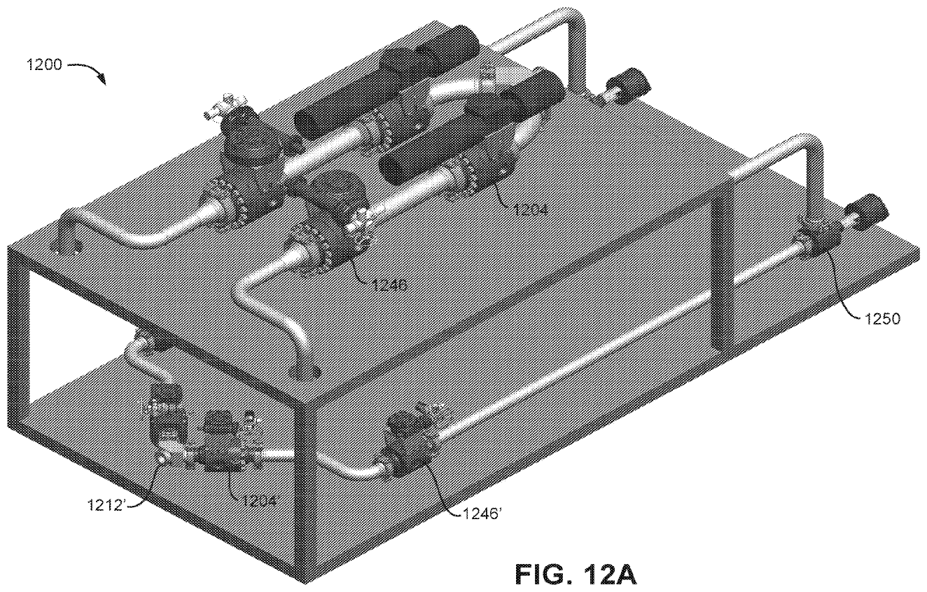

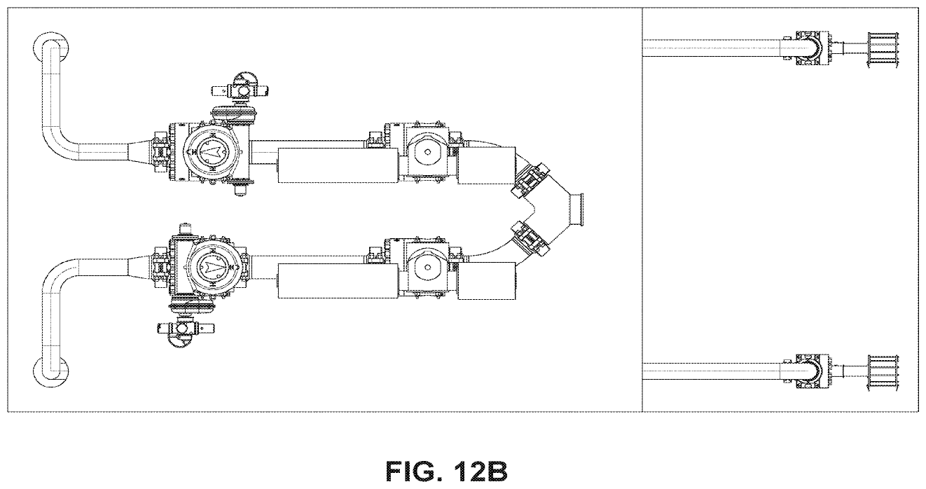

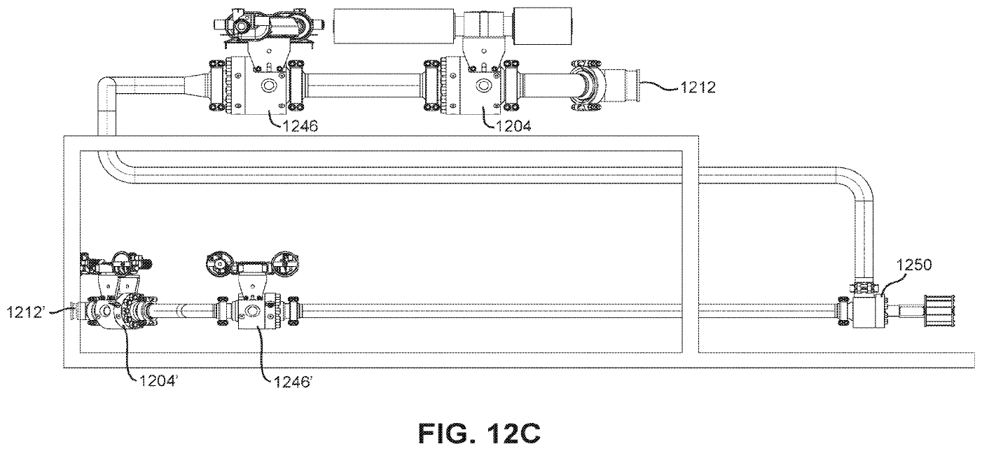

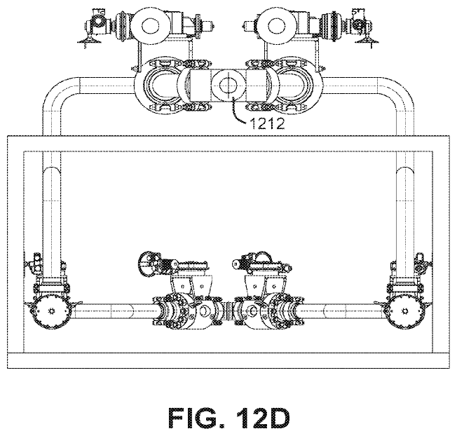

FIGS. 12A-14D illustrate a skid including several new features that are designed to reduce the pressure stress on the control valves and other pipe components. In a pressure let-down skid, control valves are a key part of stepping down the pressure of the process flow that is received at the inlet of the skid, so that it can exit the outlet of the skid at a reduced level of pressure. A control valve typically includes a trim stack that introduces several right angle turns in the path of the process that forces the flow to slow down when flowing through the multiple stages of the control valve. When the input flow is at a very high pressure and/or is turbulent, the wear on the trim stack can be substantial and may require the control valve to be repaired or replaced more often over time.

Thus, it is desirable that the flow that enters the control valve is at lesser levels of pressure and is substantially laminar. Manufacturers typically recommend certain pipe run length requirements immediately preceding the control valve input, and also immediately after the output. For example, some control valves are recommended an input run length that is five times the diameter and output pipe run length that is at least 15 times the diameter. This is recommended to reduce the wear on the trim in the control valve, by attempting to make the incoming high-pressure flow laminar, and also the outgoing flow laminar. The more laminar the flow that flows through the control valve, the less wear imposed on the trim in the control valve, which in turn may translate to less repair, less downtime and less of a cost of operation for the skid.

In skid environments, it is sometimes important to have the inlet and/or outlet at the usual locations as in conventional skids. In a typical usage scenario, the inlet of an example skid is connected to a reactor (an ebullated bed reactor) which pushes its outgoing liquid at high pressure into the skid through the inlet of the skid. The flow is cooled down and also its pressure is reduced (this is a reason for the term for the skid as a “pressure letdown skid”) by the control valve, and in example embodiments also other components of the piping, before the flow exits through the outlet of the skid.

Conventionally, and in some example embodiments, the control valve in each leg of the skid is located relatively near the isolation valve. However, in some other embodiments, the inventors have located the control valve at a substantial distance from the isolation valve with the goal of using the pipe length between the second isolation valve and the control valve as part of (or an extension of) the control valve system that is purposely designed to slow down the flow. The inventors add a Thermal Stress Expansion Pipe Run (TSEPR) (shown in FIGS. 12A-14D) and flip the bottom piping layout 180 degrees so that the inlet and outlet are on opposite sides of the skid. The TSEPR may run as close as possible to the ceiling of the bottom of the upper platform, and where the pipe run through the upper platform, there should be a slot for the pipe to expand and move. In some example embodiments such as that shown in FIGS. 12A-12D, in a two-level skid design 1200, the control valve 1250 is located in the lower portion of the skid (whereas the second isolation valve in the input leg is in the upper portion) at a substantial distance from the second input isolation valve 1246 in order to allow a longer length input pipe and output pipe immediately before and after the control valve 1250 to encourage the flow to be more laminar.

In some example embodiments, the inventors have located the control valve 1250 substantially further away from the isolation valve 1246 (e.g., compare conventional location next to isolation valve to the new location), and moreover have introduced multiple (e.g., three in the illustrated embodiment of FIG. 12A) right-angle turns in the piping between the isolation valve 1246 and the input to the control valve 1250, thus using a part of the input piping as an extension of the control valve in slowing down the incoming flow before it reaches the trim stack in the control valve thereby substantially reducing the risk (e.g., by reducing the pressure and/or velocity of the flow) of wear on the trim stack.

The added number of bends in the input pipe to the control valve, also provides for the hot leg (i.e., the leg that is being actively used to transport fluid) to dynamically/temporarily expand to be longer than the cold-leg between the input and output of the skid. Providing the space and capability for the piping to expand (e.g., lengthen) when it is hot is important to avoid exerting additional expansion pressure on the inlet and/or outlet of the skid in order to avoid damage and leaks. The TSEPR can be run just under the ceiling of the upper platform as shown in FIGS. 12A-12D or run parallel and on same upper platform horizontal plane. This may depend on piping clearance and work space to access to service all the isolation valves on the upper platform. FIG. 12A shows a perspective view of the skid design 1200 according to an embodiment. FIGS. 12B, criss12C and 12D illustrate a top view, a side view and a front-to-back (inlet side to outlet side) view, respectively, of the skid 1200. In FIGS. 12A-12D show the inlet 1212, input first isolation valve 1204, input second isolation valve 1246, control valve 1250, output second isolation valve 1246′, output first isolation valve 1204′, and outlet 1212′, for the skid 1200.

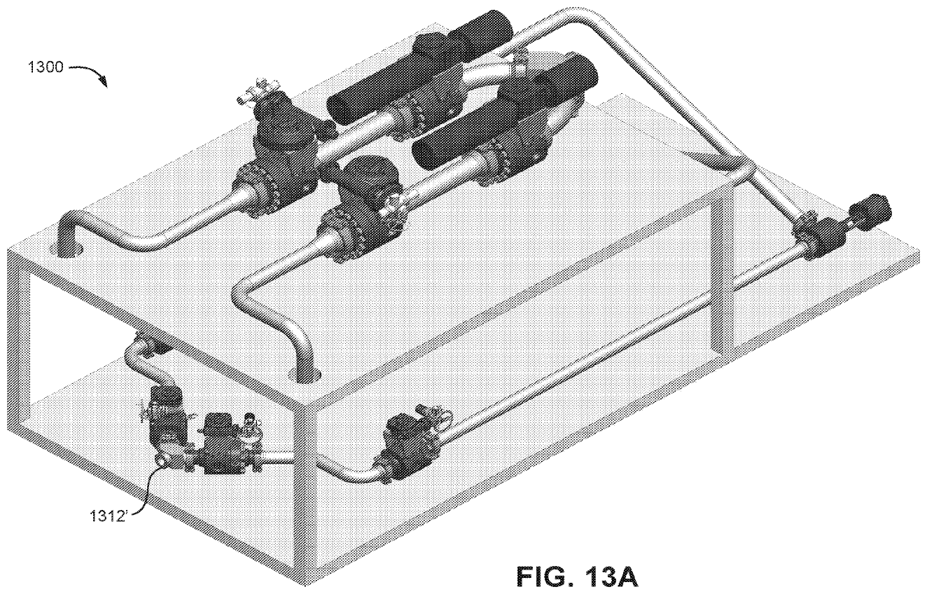

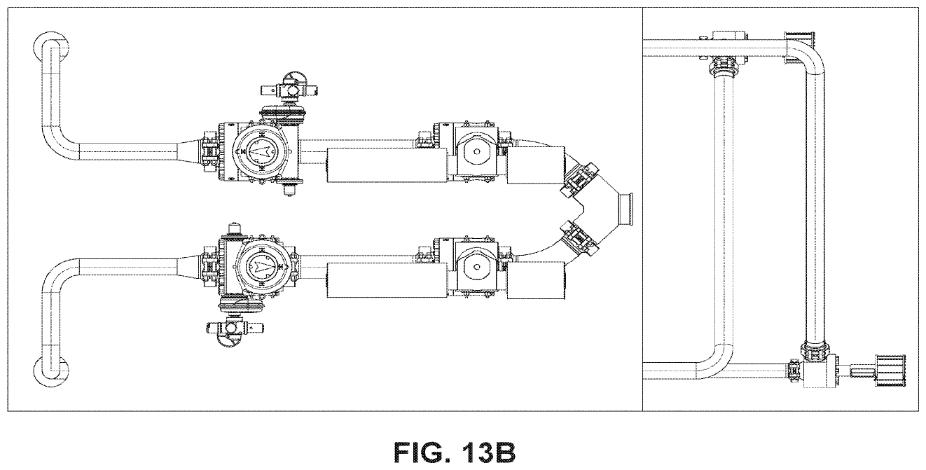

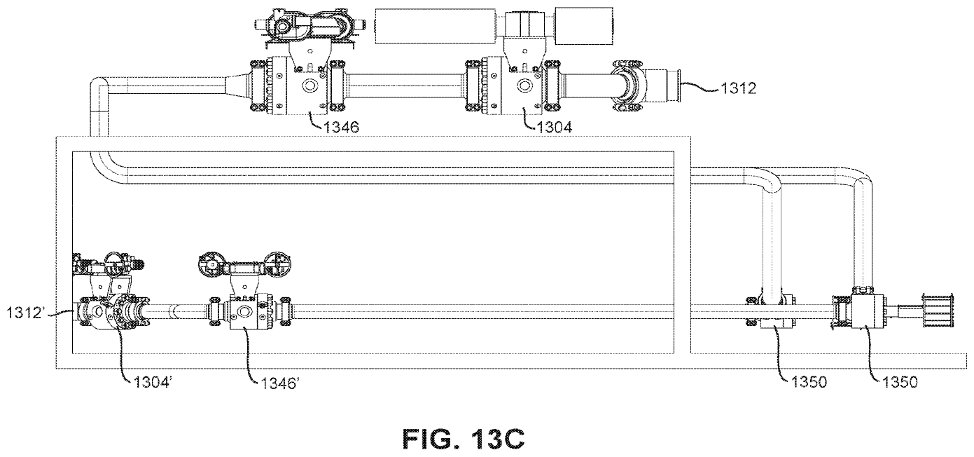

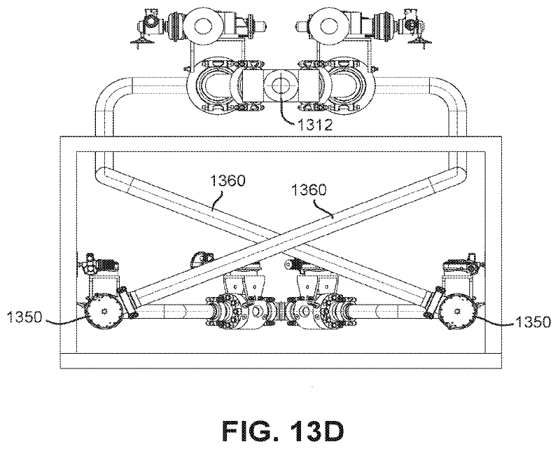

In another embodiment, such as that shown in the skid 1300 shown in FIG. 13A, the additional length extensions described above in relation to the skid 1200 can be enhanced by crossing diagonally over the right input leg to the left control valve, and vice versa. See crisscross patterned input extensions 1360 that directs the left input leg flow to the right control valve 1250 and right output leg, and the right input leg flow to the left control valve 1250 and left output leg. FIG. 13A shows a perspective view of the skid design 1300 according to an embodiment. FIGS. 13B, 13C and 13D illustrate a top view, a side view and a front-to-back (inlet side to outlet side) view, respectively, of the skid 1300. In FIGS. 13A-13D show the inlet 1312, input first isolation valve 1304, input second isolation valve 1346, control valve 1350, output second isolation valve 1346′, output first isolation valve 1304′, and outlet 1312′, for the skid 1300.

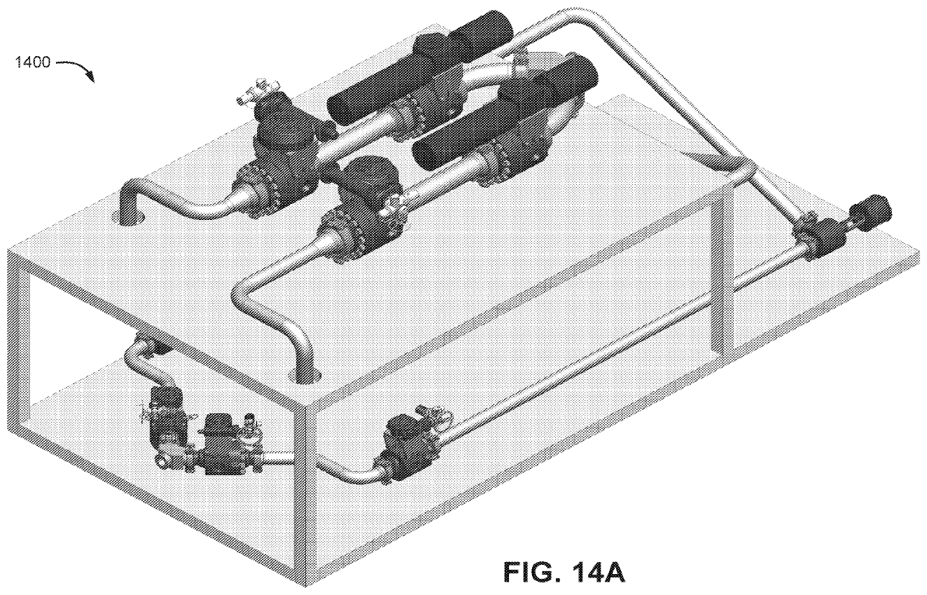

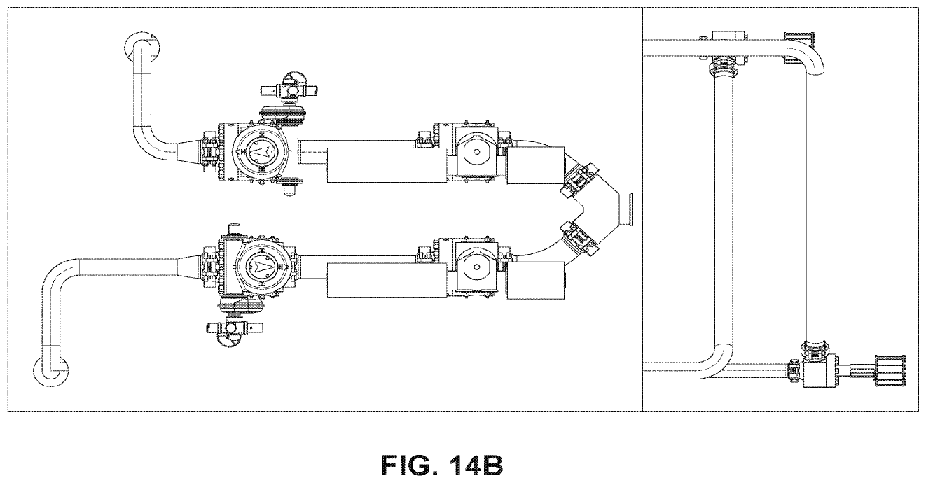

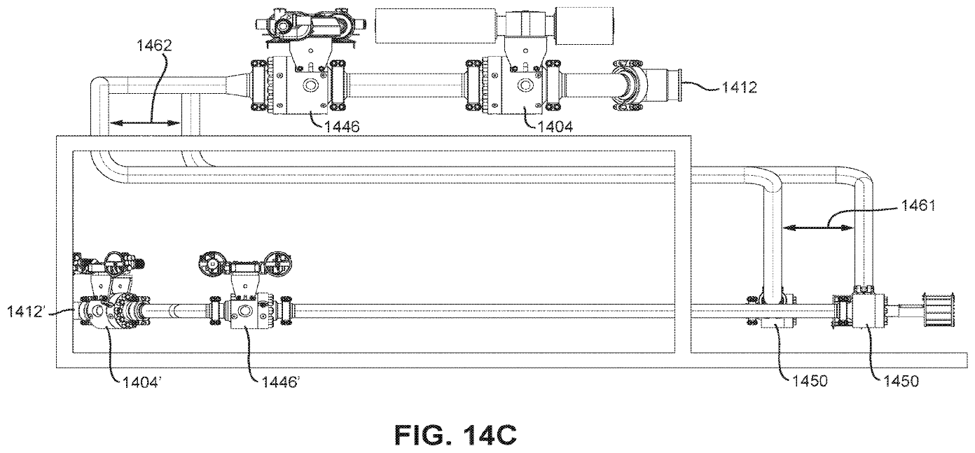

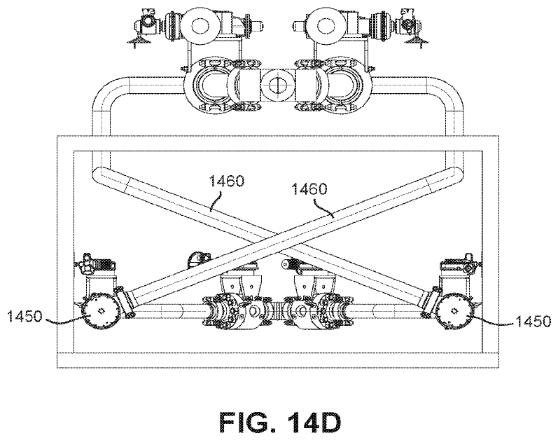

FIG. 14A illustrates a skid 1400 in another embodiment. Skid 1400 is similar to skid 1300 described above and includes an crisscrossed input extension 1460 in a manner similar to crisscrossed input extensions 1360. However, in order to provide more space (e.g., to facilitate access to the control valves 1450) between the crisscrossed input extensions 1460, a spacing is introduced between the right input leg and the left input leg as indicated by the spacings 1461 and 1462 between the pipes. The spacings 1461 and 1462 may be the same or different (e.g., the TSEPR on the two legs can be of the same of different lengths). FIG. 14A shows a perspective view of the skid design 1300 according to an embodiment. FIGS. 14B, 14C and 14D illustrate a top view, a side view and a front-to-back (inlet side to outlet side) view, respectively, of the skid 1400. In FIGS. 14A-14D show the inlet 1412, input first isolation valve 1404, input second isolation valve 1446, control valve 1450, output second isolation valve 1446′, output first isolation valve 1404′, and outlet 1412′, for the skid 1400.

In yet another embodiment additional length extension can be achieved by extending the input run by adding a u-pattern to the input piping just before the control valve in a manner that the entire added pattern is outside of the upper level platform of the skid. For example, immediately after the input leg shown in FIG. 12A extends beyond from under the upper platform, an upward turn followed by a horizontal turn and a downward turn can be implemented so that the input pipe enters the control valve at a right angle to the output leg. The turns prior to the control valve may help slow the flow before the flow enters the control valve.

While the above described additional length and additional bends (including the TPESR) are designed to reduce the pressure stresses on the control valves, they also reduce stresses on the entire piping system. Thus, the above features facilitate skids with reduced leakage at the isolation valves, inlet, outlet, etc.

Additionally, in some embodiments, optionally in combination with one or more of the features described in relation to FIGS. 12A-14D, the stresses are further reduced by introducing a swivel joint at one or more of the bends in the piping in the TSEPR so that the piping can be allowed to expand and contract as needed in “origami”-like arrangements. For example, in an embodiment, if swivel joints were to be inserted at each of the turns shown in the input leg between the second isolation valve 1446 and control valve 1450, expansion and contraction would be further facilitated by enabling the vertical portions of that input piping to expand vertically by allowing the horizontal portion of the pipe to move horizontally. In example embodiments, the access area to the valves on the outer sides of the pipe runs on the skid upper platform can be maximized by maximally reducing the spacing between the two input legs on the upper platform while maximally extending the spacing between the long portion of the input leg on the upper platform, and the slot through which the input piping is directed to the control valve and the lower platform. This would enhance the length of the piping portion involved in the above described crisscross pattern (“scissor effect”). The valve access on the lower platform can be enhanced by arranging the long pipe runs towards the outside of the lower platform, thus allowing valve access from the area between the two long pipe runs of the two legs, while also enhancing the length of the TSEPR in the crisscross pattern segment. The slot through which the input piping is directed to the control valve and the lower platform may be made sufficiently large to enable expansion of the piping.

Each of the FIGS. 1A-14D illustrates modular skids (e.g., FIGS. 9A-9B, 12A-12D. 13A-13D, and 14A-14D) and fluid flow components configured for use in modular skids such as, for example, the illustrated modular skids. Some embodiments of this disclosure may comprise modular skids in which fluid flow components described in relation to FIGS. 1A-8B and 10A-11C or aspect incorporated in any of the illustrated modular skids of FIGS. 9A-9B or 12A-14D are combined in a manner not illustrated in the figures. For example, and without limitation, a modular skid shown in FIGS. 12A-14D may further include one or more reducers, expanders, integrated components, and/or Y-patterned globe valves described in relation to FIGS. 1A-11B. Further, for example and without limitation, a modular skid such as that shown in FIGS. 9A-9B may further include one or more aspects such as the additional turns in the piping between isolation valve and control valve, crisscross patterns, spacings, etc., that were described in relation to FIGS. 12A-14D.

A modular skid according to some embodiments may comprise any one of, or a combination of, the arrangements 100, 200, 300, 400, 500, 600, 600′, 700, 800, 1000, and 1100. In some embodiments, such any one arrangement or combination of arrangements, may be combined with one or more aspects shown in any of example modular skids 900, 1200, 1300, and 1400. In example embodiments, arrangements 100, 200, 300, 400, 500, 600, 600′, 700, 800, 1000, and 1100, and modular skids 900, 1200, 1300 and 1400 are configured to use in severe service applications, such as, for example and without limitation, ebullated bed hydrocracking applications. Although referred above as a pressure letdown skid, modular skids according to some embodiments can also be used for reducing the velocity of the flow before the control valve.

It has been observed that modular skids in accordance with embodiments of this disclosure, which may include more loops and bends/turns, possesses sufficient intrinsic flexibility to enable the inlet and outlet of the skid to be fixed in place during operation. By having the option to secure the inlet and outlet connections, users can ensure that any deformation occurring before or after the skid has minimal impact on the skid itself. Having the inlet and outlet fixed in place enables avoiding many of the problems in conventional skids that stem from using floating inlet and outlet connections. In some conventional skids these connections are left floating to provide additional flexibility, compensating for the inherent rigidity of the skid. However, having floating inlet and outlet connections causes any deformation from upstream or downstream to be transmitted to the skid, thereby exacerbating the overall piping stress on the skid.

In an example implementation, a modular skid is configured for use in connection with an ebullated bed application and comprises at least two flow paths between an inlet and an outlet, each flow path including a reducer, an expander, and an isolation valve arranged before a control valve. In each of the at least two flow paths, a bore of a pipe connecting to an input of the reducer is larger than a bore of a pipe connecting to an output of the reducer, and, in each of the at least two flow paths, a bore of a pipe connecting to an input of the expander is smaller than a bore of a pipe connecting to an output of the expander.

The modular skid according to the immediately preceding paragraph may be a pressure let down skid, and/or may be configured to reduce a velocity of media flowing in piping of the modular skid before the control valve.

The modular skid according to any of the above two paragraphs, where each of the at least two flow paths may include the reducer arranged before the isolation valve and an expander arranged after the control valve. The inlet may comprise a Y-connector, and each of the isolation valves may be connected to the Y-connector by a respective one of the reducers. The outlet may comprise a second Y-connector, and each of the isolation valves may be connected to the second Y-connector by a respective one of the expanders. On each of the flow paths at least one other fluid flow control device may be arranged between the reducer and the isolation valve and/or between the expander and the control valve. The at least one other fluid flow control device may be a Y-pattern globe valve, or the at least one other fluid flow control device may be a ball valve, and, on each flow path, the isolation valve and the ball valve may be arranged in a single integrated component.

The modular skid according to any of the above three paragraphs, wherein the Y connector is respectively clamped to each of the reducers and each of the reducers is clamped to a respective one of the isolation valves, wherein the Y-connector and each of the reducers form one integrated unit and each of the isolation valves is clamped to the each of the reducers of the integrated unit, wherein on each of the flow paths the reducer and the isolation valve form a respective integrated unit, and wherein the Y-connector is clamped to the each respective integrated unit, or wherein each of the at least two flow paths includes a second reducer arranged after the isolation valve. On each of the at least two flow paths, the second reducer and the isolation valve may be formed as an integrated unit. An output of the second reducer may be of smaller bore-width than an output of the first reducer.

The modular skid according to any of the above four paragraphs, where each of the at least two flow paths includes a reducer arranged after a isolation valve and before the control valve. On each of the at least two flow paths, the isolation valve and the reducer arranged after the isolation valve may form an integrated unit clamped to the Y-connector.

The modular skid according to any of the above five paragraphs, where the inlet comprises a three-way ball valve, and wherein each of the isolation valves is connected to the three-way ball valve by a respective one of the reducers. The three-way ball valve may comprise an input opening and three output openings, where the input opening is connected to the inlet in a vertical direction and the output openings are arranged in a horizontal plane and are distributed around a vertical axis of the three-way ball valve.

The modular skid according to any of the above six paragraphs, where said each flow path including a Y-pattern globe valve.

The modular skid according to any of the above seven paragraphs, where the inlet comprises a Y-connector integrated with at least two Y-pattern globe valves, and wherein each of the Y-pattern globe valves connect to a respective one of the flow paths.

In an example implementation, a modular skid comprises at least two flow paths between an inlet and an outlet, each flow path includes an isolation valve arranged before a control valve in a piping, where a pipe run between the isolation valve and the control valve includes a plurality of right-angle turns in the piping.

The modular skid according to the immediately preceding paragraph, where the inlet and the outlet are oriented in opposite directions of the modular skid.

The modular skid according to any of the preceding two paragraphs, where one or more of the plurality of turns are implemented with swivel-joints. The swivel-joints may be arranged to provide for expansion and contraction of each said piping by enabling vertical portions of said piping to expand vertically by enabling a horizontal portion of said piping to move horizontally.

The modular skid according to any of the preceding three paragraphs, where each of the flow paths has an upper portion including the isolation valve arranged in relation to an upper platform and a lower portion including the control valve arranged in relation to a lower platform.

The modular skid according to any of the preceding four paragraphs, where each of the flow paths has an upper portion and a lower portion, the upper portion of a first flow path is arranged on a left side of the skid and the lower portion of the first flow path is arranged on a right side of the skid, the upper portion of a second flow path is arranged on a right side of the skid and the lower portion of the second flow path is arranged on a left side of the skid, the pipe run of the first flow path includes an extension that is diagonally arranged to connect the upper portion of the first flow path to the control valve arranged in the lower portion of the first flow path, and the pipe run of the second flow path includes an extension that is diagonally arranged to connect the upper portion of the second flow path to the control valve arranged in the lower portion of the second flow path. The piping of the at least two flow paths may be of different lengths.

The modular skid according to any of the preceding five paragraphs, where an access area to valves on outer sides of the pipe runs on an upper platform of the modular skid is maximized by maximally reducing spacing between two input legs on the upper platform while maximally extending spacing between a long portion of the input leg on the upper platform, and a slot through which the input piping is directed to the control valve and a lower platform of the modular skid.

The modular skid according to any of the preceding six paragraphs, where a spacing in the horizontal input to output direction is introduced between respective vertical portions of the piping of each of the at least two flow paths.

The modular skid according to any of the preceding seven paragraphs, further comprising at least one reducer and at least one expander included in the piping of each flow path.

The modular skid according to any of the preceding eight paragraphs, where the inlet and/or outlet may comprise a Y-connector or a three-way ball valve.

The modular skid according to any of the preceding nine paragraphs, where external connections to the inlet and outlet are fixed in place.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A modular skid configured for use in connection with an ebullated bed application and comprising at least two flow paths between an inlet and an outlet, each flow path including a reducer, an expander, and an isolation valve arranged before a control valve, wherein, in each of the at least two flow paths, a bore of a pipe connecting to an input of the reducer is larger than a bore of a pipe connecting to an output of the reducer, and wherein, in each of the at least two flow paths, a bore of a pipe connecting to an input of the expander is smaller than a bore of a pipe connecting to an output of the expander.

2. The modular skid according to claim 1, wherein the modular skid is a pressure let down skid.

3. The modular skid according to claim 1, wherein the modular skid is configured to reduce a velocity of media flowing in piping of the modular skid before the control valve.

4. The modular skid skid according to claim 1, wherein each of the at least two flow paths includes the reducer arranged before the isolation valve and an expander arranged after the control valve.

5. The modular skid according to claim 4, wherein the inlet comprises a Y-connector, and wherein each of the isolation valves is connected to the Y-connector by a respective one of the reducers.

6. The modular skid according to claim 5, wherein the outlet comprises a second Y-connector, and wherein each of the isolation valves is connected to the second Y-connector by a respective one of the expanders.

7. The modular skid according to claim 6, wherein on each of the flow paths at least one other fluid flow control device is arranged between the reducer and the isolation valve and/or between the expander and the control valve.

8. The modular skid according to claim 7, wherein the at least one other fluid flow control device is a Y-pattern globe valve.

9. The modular skid according to claim 7, wherein the at least one other fluid flow control device is a ball valve, and, on each flow path, the isolation valve and the ball valve are arranged in a single integrated component.

10. The modular skid according to claim 5, wherein the Y connector is respectively clamped to each of the reducers and each of the reducers is clamped to a respective one of the isolation valves.

11. The modular skid according to claim 5, wherein the Y-connector and each of the reducers form one integrated unit, and wherein each of the isolation valves is clamped to the each of the reducers of the integrated unit.

12. The modular skid according to claim 5, wherein, on each of the flow paths, the reducer and the isolation valve form a respective integrated unit, and wherein the Y-connector is clamped to the each respective integrated unit.

13. The modular skid according to claim 5, wherein each of the at least two flow paths includes a second reducer arranged after the isolation valve.

14. The modular skid according to claim 13, wherein, on each of the at least two flow paths, the second reducer and the isolation valve are formed as an integrated unit.

15. The modular skid according to claim 14, wherein an output of the second reducer is of smaller bore-width than an output of the first reducer.

16. The modular skid according to claim 1, wherein each of the at least two flow paths includes a reducer arranged after a isolation valve and before the control valve.

17. The modular skid according to claim 16, wherein, on each of the at least two flow paths, the isolation valve and the reducer arranged after the isolation valve form an integrated unit clamped to the Y-connector.

18. The modular skid according to claim 4, wherein the inlet comprises a three-way ball valve, and wherein each of the isolation valves is connected to the three-way ball valve by a respective one of the reducers.

19. The modular skid according to claim 18, wherein the three-way ball valve comprises an input opening and three output openings, wherein the input opening is connected to the inlet in a vertical direction and the output openings are arranged in a horizontal plane and are distributed around a vertical axis of the three-way ball valve.

20. The modular skid according to claim 1, wherein said each flow path including a Y-pattern globe valve.

21. The modular skid according to claim 1, wherein the inlet comprises a Y-connector integrated with at least two Y-pattern globe valves, and wherein each of the Y-pattern globe valves connect to a respective one of the flow paths.

22. A modular skid comprising at least two flow paths between an inlet and an outlet, each flow path including an isolation valve arranged before a control valve in a piping, wherein a pipe run between the isolation valve and the control valve includes a plurality of right-angle turns in the piping.

23. The modular skid according to claim 22, wherein the inlet and the outlet are oriented in opposite directions of the modular skid.

24. The modular skid according to claim 22, wherein one or more of the plurality of turns are implemented with swivel-joints.

25. The modular skid according to claim 24, wherein the swivel-joints are arranged to provide for expansion and contraction of each said piping by enabling vertical portions of said piping to expand vertically by enabling a horizontal portion of said piping to move horizontally.

26. The modular skid according to claim 22, wherein each of the flow paths has an upper portion including the isolation valve arranged in relation to an upper platform and a lower portion including the control valve arranged in relation to a lower platform.

27. The modular skid according to claim 22, wherein each of the flow paths has an upper portion and a lower portion, the upper portion of a first flow path is arranged on a left side of the skid and the lower portion of the first flow path is arranged on a right side of the skid, the upper portion of a second flow path is arranged on a right side of the skid and the lower portion of the second flow path is arranged on a left side of the skid, the pipe run of the first flow path includes an extension that is diagonally arranged to connect the upper portion of the first flow path to the control valve arranged in the lower portion of the first flow path, and the pipe run of the second flow path includes an extension that is diagonally arranged to connect the upper portion of the second flow path to the control valve arranged in the lower portion of the second flow path.

28. The modular skid according to claim 27, wherein the piping of the at least two flow paths are of different lengths.

29. The modular skid according to claim 22, wherein an access area to valves on outer sides of the pipe runs on an upper platform of the modular skid is maximized by maximally reducing spacing between two input legs on the upper platform while maximally extending spacing between a long portion of the input leg on the upper platform, and a slot through which the input piping is directed to the control valve and a lower platform of the modular skid.

30. The modular skid according to claim 22, wherein a spacing in the horizontal input to output direction is introduced between respective vertical portions of the piping of each of the at least two flow paths.

31. The modular skid according to claim 22, further comprises at least one reducer and at least one expander included in the piping of each flow path.

32. The modular skid according to claim 22, wherein the inlet and/or outlet may comprise a Y-connector or a three-way ball valve.

33. The modular skid according to claim 22, wherein external connections to the inlet and outlet are fixed in place.
